(19) United States
(12) Patent Application Publication
(10) Pub. No.: US 2026/0310351 A1
(43) Pub. Date: Oct. 8, 2026

(54) NONVOLATILE MEMORY DEVICE INCLUDING INPUT/OUTPUT PAD, STORAGE SYSTEM COMPRISING NONVOLATILE MEMORY DEVICE, AND METHOD OF OPERATING NONVOLATILE MEMORY DEVICE

(71) Applicant: Samsung Electronics Co., Ltd., Suwon-si (KR)

(72) Inventors: Hyunsuk Kang, Suwon-si (KR); Sangyun Kim, Suwon-si (KR); Kyoungtae Kang, Suwon-si (KR); Dongku Kang, Suwon-si (KR); Jindo Byun, Suwon-si (KR); Youngdon Choi, Suwon-si (KR); Sanggi Hong, Suwon-si (KR)

(73) Assignee: Samsung Electronics Co., Ltd., Suwon-si (KR)

(21) Appl. No.: 19/630,212

(22) Filed: Mar. 26, 2026

(30) Foreign Application Priority Data
Mar. 27, 2025 (KR) 10-2025-0039855
May 14, 2025 (KR) 10-2025-0062789

(51) Int. Cl. G06F 3/06

(52) U.S. Cl. CPC G06F 3/061; G06F 3/0659; G06F 3/0679

(57) ABSTRACT

A nonvolatile memory device includes a plurality of memory chips. Each of the plurality of memory chips may include a memory cell array including a plurality of planes and configured to store data, a command-address pad configured to receive a status output start command and an output command, at least one status output pad configured to sequentially output status signals, respectively corresponding to operating statuses of the plurality of planes, based on the status output start command, and an input/output pad configured to sequentially output at least a portion of data stored in the plurality of planes based on the status signal and the output command.

### CROSS-REFERENCE TO RELATED APPLICATIONS

This present application claims priority to and the benefit under 35 U.S.C. §119(a)-(d) of Korean Patent Application No. 10-2025-0039855, filed on Mar. 27, 2025, in the Korean Intellectual Property Office, and Korean Patent Application No. 10-2025-0062789, filed on May 14, 2025, in the Korean Intellectual Property Office, the entire disclosures of which are incorporated herein by reference.

### FIELD

Embodiments of the present disclosure relate to a nonvolatile memory device and more particularly to a nonvolatile memory device including an input/output pad, a storage system including a nonvolatile memory device, and a method of operating a nonvolatile memory device.

### BACKGROUND

Semiconductor memory devices may be classified into volatile memory devices and nonvolatile memory devices. Volatile memory devices have the advantage of high read and write speeds but the disadvantage of losing their stored data when their power supplies are interrupted. In contrast, nonvolatile memory devices retain their stored data even when their power supplies are interrupted. Therefore, nonvolatile memory devices are used to store data that needs to be preserved regardless of whether their power supplies are is supplied.

A typical example of a nonvolatile memory device includes a flash memory device. Flash memory devices are widely used as storage media for audio and video data in information devices such as computers, mobile phones, smartphones, personal digital assistants (PDAs), digital cameras, camcorders, voice recorders, MP3 players, handheld PCs, gaming consoles, fax machines, scanners, printers, or the like. As the number of information devices using nonvolatile memory devices as storage media has increased recently, there is a growing demand for improved data input/output efficiency.

### SUMMARY

Embodiments of the present disclosure provide a storage system configured to improve data input/output efficiency.

According to embodiments, a nonvolatile memory device includes a plurality of memory chips. Each of the plurality of memory chips may include a memory cell array including a plurality of planes and configured to store data, a command-address pad configured to receive a status output start command and an output command, at least one status output pad configured to sequentially output status signals, respectively corresponding to operating statuses of the plurality of planes, based on the status output start command, and an input/output pad configured to sequentially output at least a portion of data stored in the plurality of planes based on the status signal and the output command.

According to embodiments, a method of operating a nonvolatile memory device includes receiving a status output start command, sequentially outputting at least one status signal corresponding to an operating status of a data read operation on each of a plurality of planes based on the status output start command, receiving an output command, sequentially outputting at least a portion of data stored in the plurality of planes based on the output command, receiving a status output termination command, and terminating the output of the at least one status signal based on the status output termination command.

According to embodiments, a storage system includes a nonvolatile memory device configured to store data and a memory controller configured to receive data from the nonvolatile memory device or provide data to the nonvolatile memory device. The memory controller may be configured to generate and output a status output start command and an output command, and the nonvolatile memory device may include a plurality of memory chips. Each of the plurality of memory chips may include a memory cell array including a plurality of planes and configured to store data, a command-address pad configured to receive the status output start command and the output command, at least one status output pad configured to sequentially output status signals, respectively corresponding to operating statuses of the plurality of planes, based on the status output start command, and an input/output pad configured to sequentially output at least a portion of data stored in the plurality of planes based on the status signal and the output command.

### BRIEF DESCRIPTION OF DRAWINGS

FIG. 1 is a diagram illustrating a storage system according to embodiments.

FIG. 2A is a diagram illustrating a memory controller according to embodiments.

FIG. 2B is a diagram illustrating a memory controller according to embodiments.

FIG. 3 is a diagram illustrating a nonvolatile memory device according to embodiments.

FIG. 4 is a circuit diagram illustrating an example of a single memory block among a plurality of memory blocks according to embodiments.

FIG. 5 is a block diagram simply showing a page buffer PB according to embodiments.

FIG. 6A is a diagram illustrating a comparative example.

FIG. 6B is a diagram illustrating a data input/output sequence of the comparative example of FIG. 6A.

FIG. 7A is a diagram illustrating a comparative example.

FIG. 7B is a diagram illustrating a data input/output sequence of the comparative example of FIG. 7A.

FIG. 7C is a diagram illustrating a small page-based data input/output sequence of the comparative example of FIG. 7A.
FIGS. 8A to 8C are diagrams illustrating examples of a data input/output sequence of the storage system according to embodiments of FIG. 1.

FIG. 9 is a flowchart illustrating the operation of a nonvolatile memory device according to embodiments.

FIG. 10 is a diagram illustrating a nonvolatile memory device according to embodiments.

FIG. 11 is a diagram illustrating a storage system according to embodiments of FIG. 10.

FIG. 12 is a diagram illustrating a data input/output sequence of the storage system according to the embodiments of FIGS. 10 and 11.

FIG. 13 is a flowchart illustrating a storage system according to the embodiments of FIGS. 10 and 11.

FIG. 14 is a diagram illustrating a nonvolatile memory device according to embodiments.

FIG. 15 is a diagram illustrating a storage system according to embodiments of FIG. 14.

FIG. 16 is a diagram illustrating a data input/output sequence of the storage system according to the embodiments of FIGS. 14 and 15.

FIG. 17 is a flowchart illustrating the storage system according to the embodiments of FIGS. 14 and 15.

FIGS. 18 to 20 are diagrams illustrating storage systems according to embodiments, respectively.

### DETAILED DESCRIPTION

The following description with reference to the accompanying drawings is provided to assist in a comprehensive understanding of various embodiments of the present disclosure.

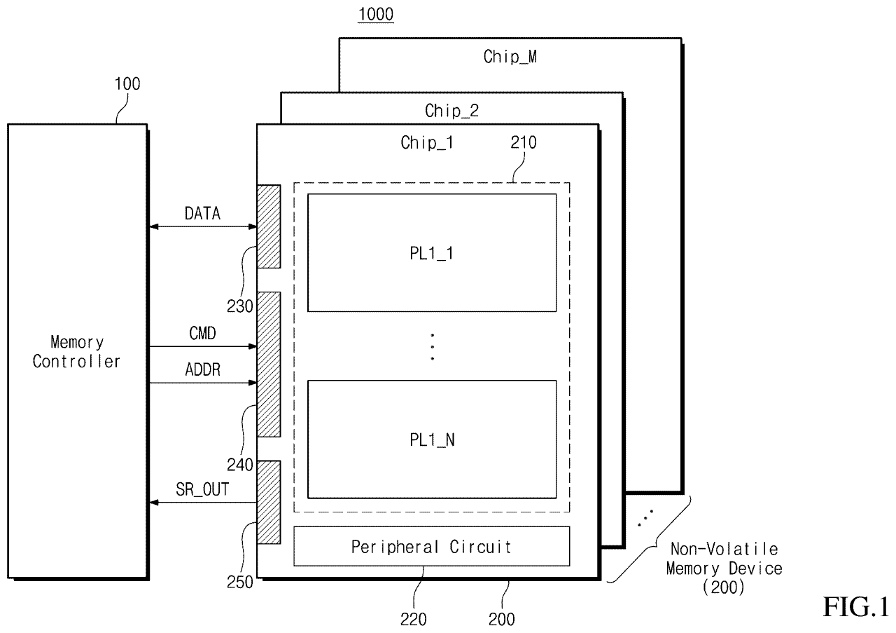

### FIG. 1

FIG. 1 is a diagram illustrating a storage system 1000 according to embodiments.

In the storage system 1000 according to embodiments, a nonvolatile memory device 200 may sequentially output a status signal SR_OUT of each of a plurality of memory chips Chip_1 to Chip_M to a memory controller 100 through a status output pad 250.

The nonvolatile memory device 200 may autonomously output a status signal SR_OUT during a processing time for a command-address requesting data reading and output. Accordingly, parallel processing of data DATA, the status signal SR_OUT, and/or a command-address CA may be performed, and the processing time for the command-address requesting data reading and output may be reduced. As a result, the data input/output efficiency of the storage system 1000 may be enhanced.

The storage system 1000 will be described in more detail with reference to FIG. 1. Referring to FIG. 1, the storage system 1000 may include the memory controller 100 and the nonvolatile memory device 200.

The memory controller 100 may transmit a command CMD and an address ADDR requesting data input/output to the nonvolatile memory device 200. The command CMD and the address ADDR may be collectively referred to as a command-address CA.

The command CMD may comprise a read command R_CMD requesting data reading, an output command DOUT_CMD requesting data output, a write command DIN_CMD requesting data input, a status output start command CMD_1 requesting the start of a status signal SR_OUT output, and a status output termination command CMD_2 requesting the end of the status signal SR_OUT output.

Hereinafter, the status output start command CMD_1 may be referred to as a first command CMD_1, and the status output termination command CMD_2 may be referred to as a second command CMD_2.

However, this is only an example, and the types of commands CMD output by the memory controller 100 are not limited thereto.

The address ADDR may be transmitted to the nonvolatile memory device 200 along with the command CMD or independently of the command CMD. The address ADDR may correspond to at least one of the plurality of memory chips Chip_1 to Chip_M or the plurality of planes PL1 to PLM_N that operate in response to the command CMD.

The nonvolatile memory device 200 may include a plurality of memory chips Chip_1 to Chip_M, and each of the plurality of memory chips Chip_1 to Chip_M may include a memory cell array 210 and a peripheral circuit 220. Hereinafter, the plurality of memory chips Chip_1 to Chip_M will be described with reference to a first memory chip Chip_1, as an example.

The memory cell array 210 may include a plurality of planes PL1_1 to PL1_N. Each of the plurality of planes PL1_1 to PL1_N may include a memory cell configured to store data. For example, each of the plurality of planes PL1_1 to PL1_N may include a nonvolatile memory such as a NAND flash memory.

However, this is only an example, and each of the plurality of sub-planes PL1_1 to PL1_M according to embodiments may include a different nonvolatile memory such as a ferroelectric random access memory (FRAM), a magnetoresistive random access memory (MRAM), a read-only memory (ROM), an electrically erasable programmable read-only memory (EEPROM), or a NOR flash memory.

The peripheral circuit 220 may be electrically connected to the memory cell array 210 to control operations in response to requests from the memory controller 100 of the memory cell array 210.

For example, the peripheral circuit 220 may include a circuit for selecting a plane corresponding to an address ADDR, a circuit for temporarily storing data stored in the plane, or a circuit for overall control of the peripheral circuit 220 in response to a command CMD. However, this is only an example, and the peripheral circuit 220 is not limited thereto and may further include other circuits.

The nonvolatile memory device 200 may receive a command-address CA or only a command CMD through a command-address pad 240.

The nonvolatile memory device 200 may perform a data writing operation, a data reading operation, a data output operation, or the like, in response to the command-address CA of the memory controller 100.

For example, in a data writing operation, the nonvolatile memory device 200 may receive a write command DIN_CMD, an address ADDR, and data DATA from the memory controller 100. The data DATA may be received by the nonvolatile memory device 200 through an input/output pad 230. The nonvolatile memory device 200 may store the data DATA in at least one plane corresponding to the address ADDR, among the plurality of planes PL1_1 to PL1_N.

For example, in a data reading operation, the nonvolatile memory device 200 may receive a read command R_CMD and an address ADDR from the memory controller 100. In this case, the nonvolatile memory device 200 may perform a data reading operation on at least one plane corresponding to the address ADDR among the plurality of planes PL1_1 to PL1_N. The read data DATA may be temporarily stored in a page buffer circuit of the peripheral circuit.

In addition, for example, the nonvolatile memory device 200 may receive an output command DOUT_CMD and/or an address ADDR from the memory controller 100 during a data output operation. The nonvolatile memory device 200 may output the data stored in the page buffer circuit. The data DATA may be output through the input/output pad 230.

The nonvolatile memory device 200 according to embodiments may receive a first command CMD_1 from the memory controller 100. The nonvolatile memory device 200 may sequentially output a status signal SR_OUT corresponding to the operation status of each of the plurality of planes PL1_1 to PL1_N. The status signal SR_OUT may be output through a status output pad 250.

The status signal SR_OUT may be a signal indicating that the data reading operation of the nonvolatile memory device 200 has been normally completed. For example, when the nonvolatile memory device 200 normally stores the data DATA of a plane corresponding to the address ADDR in the page buffer circuit in response to a read command R_CMD and an address ADDR, a first status signal P may be output. Alternatively, for example, when the data DATA of the plane corresponding to the address ADDR is not normally stored in the page buffer circuit, a second status signal F may be output.

The case in which the second status signal F is output may include, for example, a case in which an error occurs during the process of storing the data DATA, or a case in which the data DATA has not been completely stored in the page buffer circuit.

In addition, the nonvolatile memory device 200 according to embodiments may receive a second command CMD_2 from the memory controller 100. The nonvolatile memory device 200 may terminate an operation of outputting the status signal SR_OUT for each of the plurality of planes PL1_1 to PL1_N.

As described above, the storage system 1000 according to embodiments may separately and sequentially output a status signal SR_OUT of each of the plurality of planes PL1_1 to PL1_N through the status output pad 250 based on the first command CMD_1 and the second command CMD_2.

Accordingly, the time required for a request and an actual output of the status signal SR_OUT may be reduced from the time until data DATA is actually output in response to the read command R_CMD and the output command DOUT_CMD by the nonvolatile memory device 200. As a result, the nonvolatile memory device 200 may have enhanced data input/output efficiency.

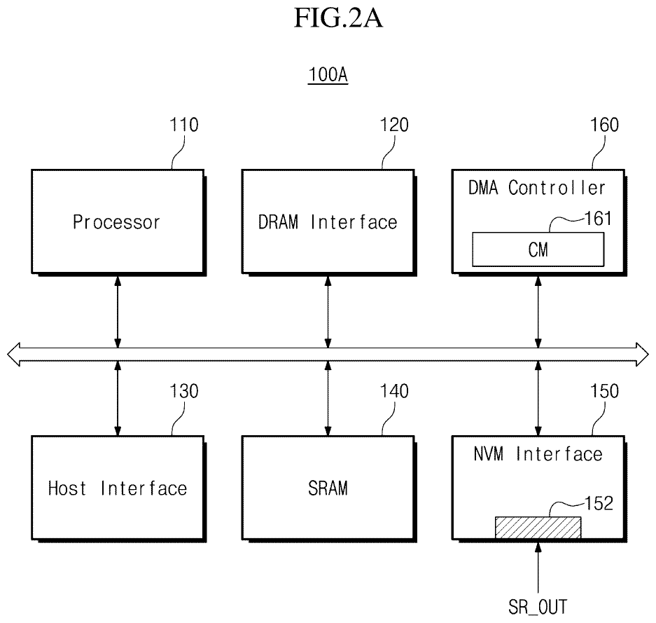

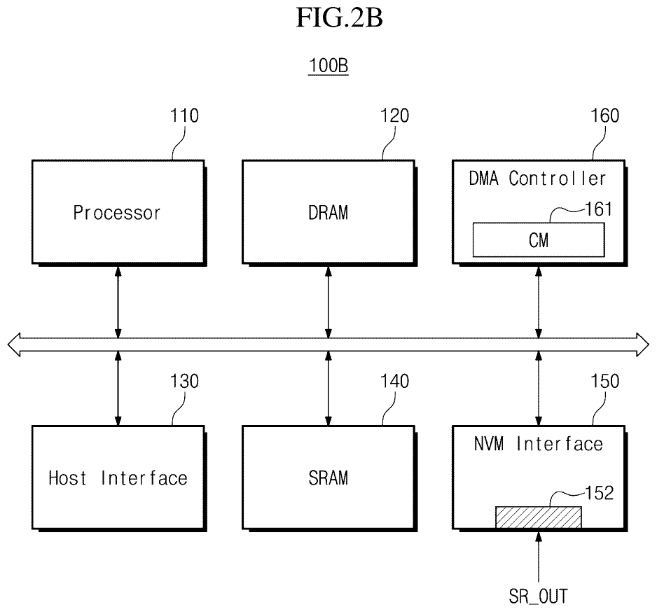

### FIG. 2A

FIG. 2A is a diagram illustrating a memory controller 100A according to embodiments. The memory controller 100A described in FIG. 2A may correspond to the memory controller 100 of FIG. 1.

Referring to FIG. 2A, the memory controller 100A may include a processor 110, a DRAM interface 120, a host interface 130, an SRAM 140, a nonvolatile memory interface 150, and a DMA controller 160.

The processor 110 may control the overall operation of the memory controller 100A. For example, the processor 110 may execute various applications executed by the memory controller 100A.

The DRAM interface 120 may provide an interface with an external DRAM device. For example, the memory controller 100A may temporarily store data in the DRAM device or output data stored in the DRAM device through the DRAM interface 120.

The host interface 130 may provide an interface with an external host. For example, the memory controller 100A may communicate with the host through the host interface 130.

The host interface 130 may include at least one of various host interfaces such as a Peripheral Component Interconnect express (PCI-express) interface, an NVMe (nonvolatile memory express) interface, a Serial ATA (STAT) interface, a Serial Attached SCSI (SAS) interface, or a Universal Flash Storage (UFS) interface.

The SRAM 140 may be used as a buffer memory, a working memory, or a cache memory of the memory controller 100A. For example, the SRAM 140 may store various types of data such as a program, an application, and firmware executed by the processor 110.

The nonvolatile memory interface 150 may provide an interface with the nonvolatile memory device 200. For example, the memory controller 100A may communicate with the nonvolatile memory device 200 through the nonvolatile memory interface 150.

For example, the memory controller 100A may receive a status signal SR_OUT from the nonvolatile memory device 200 through the nonvolatile memory interface 150. In this case, the nonvolatile memory interface 150 may include a status input pad 152, and may receive the status signal SR_OUT from the nonvolatile memory device 200 through the status input pad 152. However, this is only an example, and the status input pad 152 may be disposed outside the nonvolatile memory interface 150 according to embodiments.

The DMA controller 160 may control data transmission between the DRAM device and the nonvolatile memory device 200. For example, a direct memory access (DMA) operation may be performed in units of planes. Data stored in the nonvolatile memory device 200 may be transmitted to the DRAM device in units of planes, or data stored in the DRAM device may be transmitted to the nonvolatile memory device 200 in units of planes.

The DMA controller 160 may further include a command manager CM 161. The command manager 161 may generate various commands CMD controlling the nonvolatile memory device 200.

In embodiments, the command manager 161 may generate commands CMD, such as the first command CMD_1, the second command CMD_2, the write command DIN_CMD, the read command R_CMD, and the output command DOUT_CMD, as described in FIG. 1.

However, this is only an example, and the command manager 161 may not be included in the DMA controller 160. For example, the command manager 161 may be included in the nonvolatile memory interface 150, the processor 110, or the like.

### FIG. 2B

FIG. 2B is a diagram illustrating a memory controller 100B according to embodiments. The memory controller 100B described in FIG. 2B may correspond to the memory controller 100 of FIG. 1. Components overlapping with those described above with reference to FIG. 2A will be omitted to avoid redundancy.

In FIG. 2A, the DRAM device has been described as being disposed outside the memory controller 100A. However, this is only an example, and embodiments are not limited thereto. For example, referring to FIG. 2B, the memory controller 100B may be implemented to include a DRAM device 170.

Also, in FIG. 2A, the DMA controller 160 has been described as being disposed inside the memory controller 100A. However, this is only an example, and embodiments are not limited thereto. According to embodiments, the DMA controller 160 may be implemented to be disposed outside the memory controller 100B.

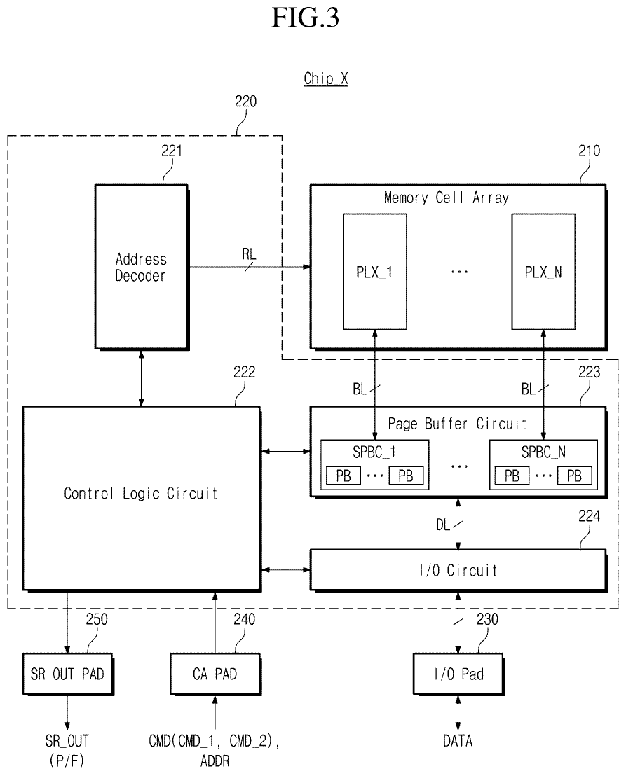

### FIG. 3

FIG. 3 is a diagram illustrating a nonvolatile memory device 200 according to embodiments.

The nonvolatile memory device 200 will be described with reference to FIG. 3 using a selected memory chip Chip_X as an example of the plurality of memory chips Chip_1 to Chip_N included in the device (see FIG. 1). The nonvolatile memory device 200 may include a memory cell array 210, a peripheral circuit 220, an input/output pad 230, a command-address pad 240, and a status output pad 250.

The memory cell array 210 may include a plurality of planes PLX_1 to PLX_N. Each of the plurality of planes PLX_1 to PLX_N may include a plurality of memory blocks. Each of the memory blocks may have a 2-dimensional structure (or a horizontal structure) or a 3-dimensional structure (or a vertical structure).

The memory cells of a memory block having a 2-dimensional structure may be formed in a direction, parallel to a substrate. The memory cells of a memory block having a 3-dimensional structure may be formed in a direction, vertical to the substrate.

The memory blocks may include at least one of a single-level cell block including single-level cells (SLCs), a multi-level cell block including multilevel cells (MLCs), a triple-level cell block including triple-level cells (TLCs), or a quad-level cell block including quad-level cells (QLCs).

The peripheral circuit 220 may include an address decoder 221, a control logic circuit 222, a page buffer circuit 223, and an input/output circuit 224.

The address decoder 221 may be electrically connected to the memory cell array 210. For example, the address decoder 221 may be electrically connected to the memory cell array 210 through row lines RL. The row lines RL may include string select lines, ground select lines, and wordlines. In addition, according to embodiments, the row lines RL may further include dummy wordlines and/or gate induced drain leakage (GIDL) lines.

The control logic circuit 222 may control the entire memory chip Chip_X. For example, the control logic circuit 222 may receive a command CMD, decode the received command CMD, and generate and output a control signal for controlling the peripheral circuit 220. Alternatively, the control logic circuit 222 may receive an address ADDR and transmit the received address ADDR to the address decoder 221. Alternatively, the control logic circuit 222 may generate a status signal SR_OUT and transmit the status signal SR_OUT to the status output pad 250. However, this is only an example, and the operation of the control logic circuit 222 is not limited thereto.

The page buffer circuit 223 may be electrically connected to the memory cell array 210. For example, the page buffer circuit 223 may be electrically connected to the memory cell array 210 through bitlines BL.

The page buffer circuit 223 may temporarily store data DATA to be stored in a selected plane or data DATA read from a selected plane. The page buffer circuit 223 may include a plurality of sub-page buffer circuits SPBC_1 to SPBC_N.

Each of the plurality of sub-page buffer circuits SPBC_1 to SPBC_N may be electrically connected to the plurality of planes PLX_1 to PLX_N. For example, a first sub-page buffer circuit SPBC_1 may be connected to a first plane PLX_1 through bitlines BL, and an Nth sub-page buffer circuit SPBC_N may be connected to an Nth plane PLX_N through bitlines BL.

The plurality of sub-page buffer circuits SPBC_1 to SPBC_N may include a plurality of page buffers PB. For example, the plurality of page buffers PB may be electrically connected to the memory blocks of each plane, respectively. Alternatively, each of the plurality of page buffers PB may be electrically connected to each of a plurality of strings included in the memory blocks of each plane. However, this is only an example, and the connection relationship between the plurality of planes PLX_1 to PLX_N and the plurality of page buffers PB is not limited thereto.

The input/output circuit 224 may be electrically connected to the page buffer circuit 223. For example, the input/output circuit 224 may be electrically connected to the page buffer circuit 223 through data lines DL.

The input/output circuit 224 may receive data DATA through the input/output pad 230 and transmit the received data DATA to the page buffer circuit 223. For example, the input/output circuit 224 may be electrically connected to the input/output pad 230 through data lines DL. Also, the input/output circuit 224 may receive data DATA from the page buffer circuit 223 and transmit the received data DATA to the memory controller 100 through the input/output pad 230.

The input/output pad 230 may receive data DATA from the memory controller 100 (see FIG. 1). The input/output pad 230 may transmit the received data DATA to the input/output circuit 224. Also, the input/output pad 230 may receive data DATA from the input/output circuit 224 and transmit the received data DATA to the memory controller 100.

The command-address pad 240 may receive the first command CMD_1, the second command CMD_2, a write command DIN_CMD, a read command R_CMD, an output command DOUT_CMD, and/or at least one address ADDR corresponding to each command CMD from the memory controller 100. The command-address pad 240 may transmit the received command-address CA or command CMD to the control logic circuit 222.

The status output pad 250 may receive a status signal SR_OUT from the control logic circuit 222. The status output pad 250 may transmit the received status signal SR_OUT to the memory controller 100.

The status signal SR_OUT output by the status output pad 250 may be a signal corresponding to the operation status of each of the plurality of planes PLX_1 to PLX_N. For example, the status signal SR_OUT may be a signal indicating whether the data DATA of each of the plurality of planes PLX_1 to PLX_N is ready to be output.

For example, the status signal SR_OUT may be a signal indicating whether the data DATA of each of the plurality of planes PLX_1 to PLX_N has been normally stored in the page buffer circuit 223. Hereinafter, the status signal SR_OUT will be described with reference to a plane PLX_1 and a sub-page buffer circuit SPBC_1 corresponding to the plane PLX_1, as examples.

For example, when data DATA stored in the plane PLX_1 is normally stored in the sub-page buffer circuit SPBC_1, the control logic circuit 222 may generate a first status signal P and transmit the generated first status signal P to the status output pad 25 in response to a read command R_CMD and an address ADDR 0.

The status output pad 250 may transmit the first status signal P to the memory controller 100, and the memory controller 100 may transmit an output command DOUT_CMD to the nonvolatile memory device 200 in response to the first status signal P.

In contrast, data DATA stored in the plane PL1 may not be normally stored in the sub-page buffer circuit SPBC_1. For example, this may include a case in which an error occurred during a data loading process or a case in which data DATA has not been completely stored in the sub-page buffer circuit SPBC_1. The control logic circuit 222 may generate a second status signal F and transmit the generated second status signal F to the status output pad 250.

The status output pad 250 may transmits the second status signal F to the memory controller 100, and the memory controller 100 may not transmit an output command DOUT_CMD to the nonvolatile memory device 200 in response to the second status signal F. Alternatively, for example, the memory controller 100 may again request the nonvolatile memory device 200 to output a status signal SR_OUT or may perform an error correction process.

In embodiments, the status signal SR_OUT of each of the plurality of planes PLX_1 to PLX_N may be independently output. For example, the first status signal P may be output for certain planes, and the second status signal F may be output for other planes. Only the certain planes for which the second status signal F has been output may again output the status signal SR_OUT, or all the planes may again sequentially output the status signal SR_OUT.

However, this is only an example, and the status signal SR_OUT may be output as a single status signal SR_OUT by combining the statuses of the plurality of planes PLX_1 to PLX_N.

As described above, the nonvolatile memory device 200 may include a status output pad 250 disposed to be separated from the input/output pad 230 and the command-address pad 240. Therefore, the nonvolatile memory device 200 may transmit the status signal SR_OUT through a separate pad from the command-address CA and the data DATA, so that the data input/output efficiency may be enhanced.

In embodiments, the nonvolatile memory device 200 may output data DATA stored in units of a plurality of page buffers PB, not in units of sub-page buffer circuits, in response to an output command DOUT_CMD. The operation of outputting data DATA in units of the plurality of page buffers PB may be referred to as a small page-based data output operation.

In the nonvolatile memory device 200 according to embodiments, latency may be reduced in the small page-based data output operation. For example, the nonvolatile memory device 200 sequentially outputs status signals SR_OUR based on the first command CMD_1, so that the status signal SR_OUT may have already been output before the input of the output command DOUT_CMD.

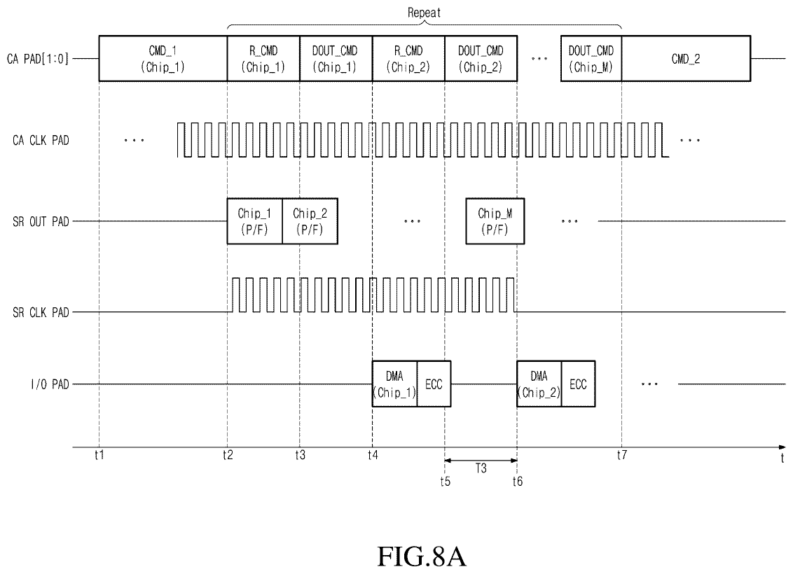

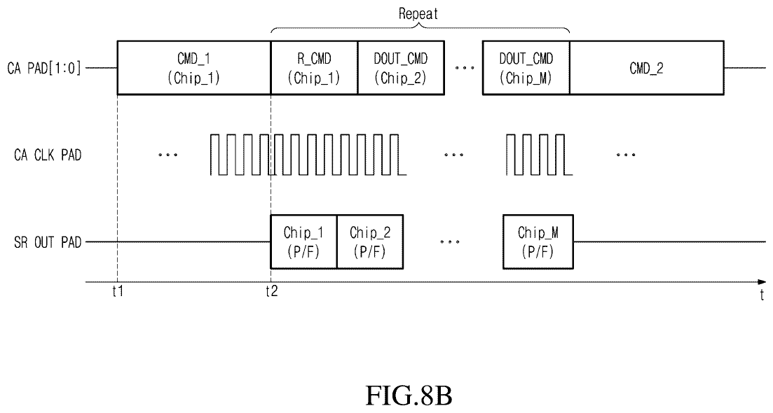

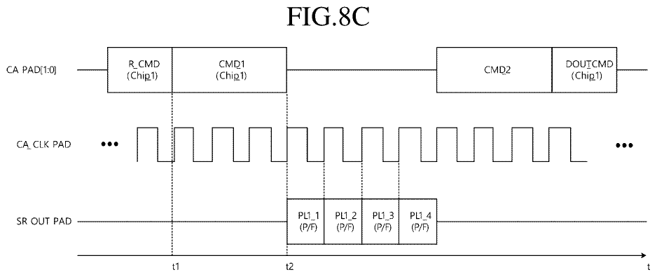

Accordingly, the latency of the nonvolatile memory device 200 may be reduced by the time required for the status signal (SR_OUT) output request operation and the status signal (SR_OUT) output operation. A detailed description will be provided later with reference to FIG. 8.

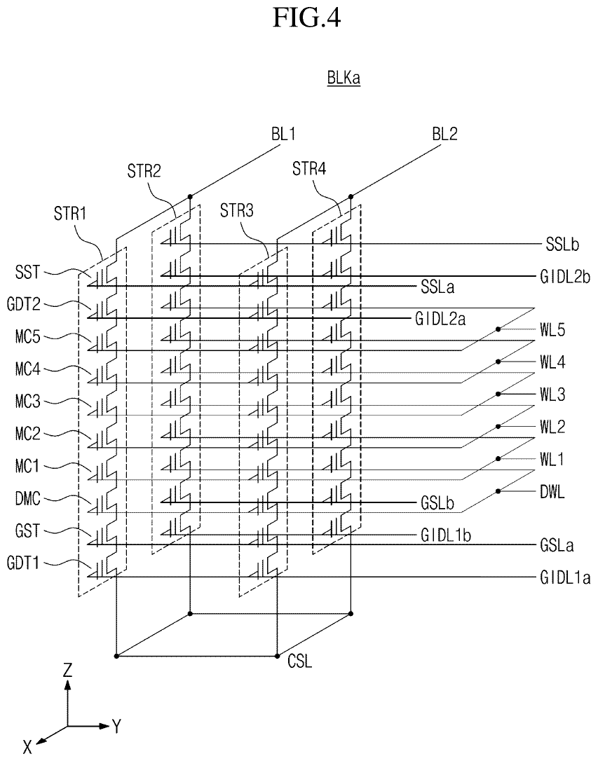

### FIG. 4

FIG. 4 is a circuit diagram illustrating an example of a memory block among a plurality of memory blocks according to embodiments.

The memory block of FIG. 4 may be one of the memory blocks included in one of the plurality of planes PL1_1 to PL1_N of FIG. 3. For clarity, an example is provided in which a single memory block includes four strings STR1 to STR4. However, this is only an example, and one memory block may include more or fewer than four strings.

Referring to FIG. 4, a memory block BLKa may include a plurality of strings STR1 to STR4, vertically stacked on a substrate. Each of the plurality of strings STR1 to STR4 may be disposed in a first direction (X-axis direction) and a second direction (Y-axis direction).

Among the plurality of strings STR1 to STR4, strings disposed in the same column may be connected to the same bitline. For example, a first string STR1 and a second string STR2 may be connected to a first bitline BL1, and a third string STR3 and a fourth string STR4 may be connected to a second bitline BL2.

Each of the plurality of strings STR1 to STR4 may include a plurality of cell transistors. The plurality of cell transistors may be stacked in a third direction (Z-axis direction). The plurality of strings STR1 to STR4 may be commonly connected to a common source line CSL.

Hereinafter, for clarity, the structure and configuration of a string will be described based on the first string STR1. Other strings STR2, STR3, and STR3 may have a structure similar to that of the first string STR1, and a detailed description thereof will be omitted.

The plurality of cell transistors may be connected in series between the first bitline BL1 and the common source line CSL. For example, the plurality of cell transistors may include GIDL transistors GDT1 and GDT2, a string select transistor SST, memory cells MC1 to MC5, a dummy memory cell DMC, and ground select transistors GST.

First GIDL transistors GDT1 may be disposed at a lowermost end of the string STR1. For example, the first GIDL transistor GDT1 may be connected to the common source line CSL at a lower end of the string STR1. However, this is only an example, and embodiments are not limited thereto. A gate of the first GIDL transistor GDT1 may be connected to a first GIDL line GIDL1a.

A second GIDL transistor GDT2 may be disposed at an upper end of the string STR2, and may be disposed between the string select transistor SST and the memory cell MC5. For example, the second GIDL transistor GDT2 may be connected to the first bitline BL1 through the string select transistor SST. A gate of the second GIDL transistor GDT2 may be connected to a second GIDL line GIDL2a.

A single string select transistor SST may be disposed at an uppermost end of a string STR. The string select transistor SST may be connected to the first bitline BL1 at the uppermost end of the string STR1. A gate of the string select transistor SST may be connected to a string select line SSLa.

A single ground select transistor GST may be provided between the dummy memory cell DMC and the first GIDL transistor GDT1. A gate of the ground select transistor GST may be connected to a ground select line GSLa.

First to fifth memory cell MC1 to MC5 may be connected in series between the string select transistor SST and the dummy memory cell DMC. Gates of the first to fifth memory cells MC1 to MC5 may be connected to first to fifth wordline WL1 to WL5, respectively.

A single dummy memory cell DMC may be provided between the first memory cell MC1 and the first GIDL transistor GDT1. A gate of the dummy memory cell DMC may be connected to a dummy wordline DWL.

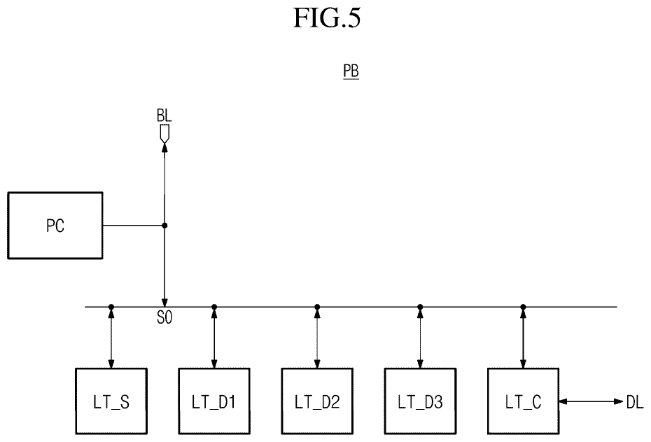

FIG. 5 is a schematic block diagram illustrating a page buffer PB according to embodiments. Page buffer PB of FIG. 5 may correspond to one of the page buffers included in the page buffer circuit 223 of FIG. 3.

Referring to FIG. 5, the page buffer PB connected to a bitline BL may be connected to the bitline BL. The page buffer PB may include a sensing node SO connected to the bitline BL. Also, the page buffer PB may include a precharge circuit PC and a plurality of latches LT_S, LT_D1 to LT_D3, and LT_C, each connected to the sensing node SO.

The precharge circuit PC may precharge the bitline BL with either a program-allowed voltage or a program-inhibited voltage, based on the control of a control logic circuit 114 (see FIG. 5).

Among the plurality of latches LT_S and LT_D1 to LT_D3, sensing latches LT_S and LT_C may store data sensed through the bitline BL. Alternatively, the sensing latch LT_S may store precharge data to be used to determine a precharge voltage.

Among the plurality of latches LT_S, LT_D1 to LT_D3, and LT_C, data latches LT_D1 to LT_D3 may temporarily store data to be programmed into a memory cell. For example, when a memory cell stores 3 bits of data, each of the data latches LT_D1 to LT_D3 may store data corresponding to a most significant page, data corresponding to an intermediate page, and data corresponding to a least significant page.

For clarity, in FIG. 5, the page buffer is illustrated as including three data latches LT_D1 to LT_D3, but this is only an example. The plurality of latches LT_S, LT_D1 to LT_D3, and LT_C may include more or fewer than three data latches.

Among the plurality of latches LT_S, LT_D1 to LT_D3, and LT_C, a cache latch LT_C may be connected to an input/output circuit 116 (see FIG. 5) through a data line DL. The cache latch LT_C may store data received from the input/output circuit 116. Alternatively, the cache latch LT_C may store data to be transmitted to the input/output circuit 116.

In FIG. 5, the page buffer PB has been described as including five latches. However, this is only an example, and the number of latches included in the page buffer PB is not limited thereto.

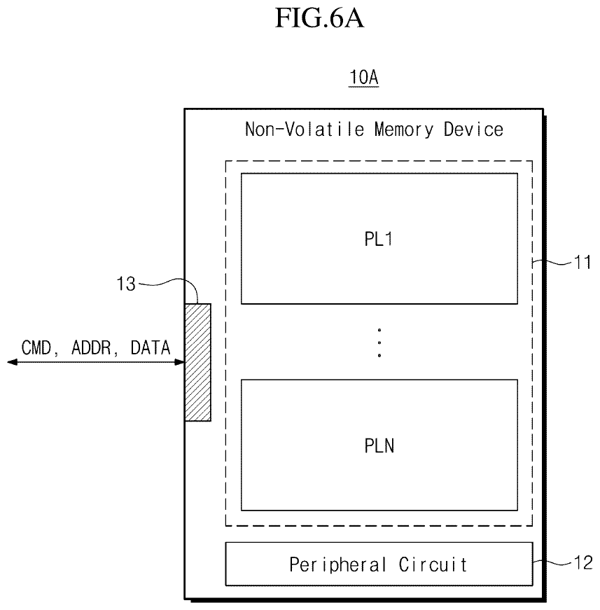

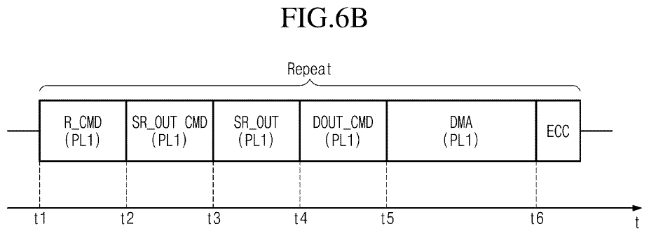

### FIG. 6A

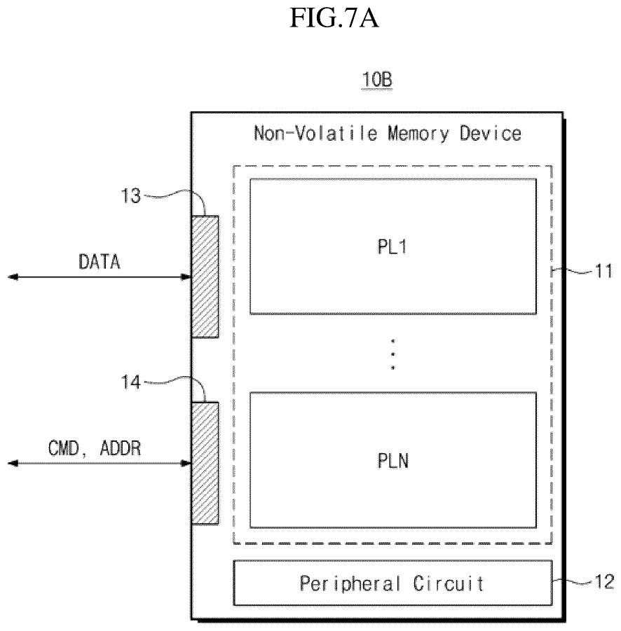

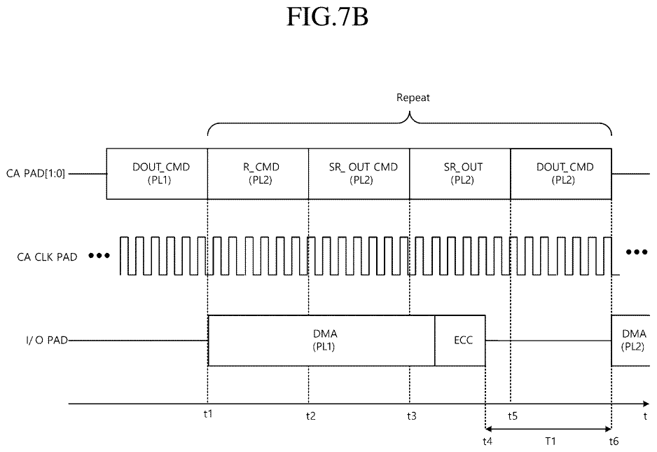

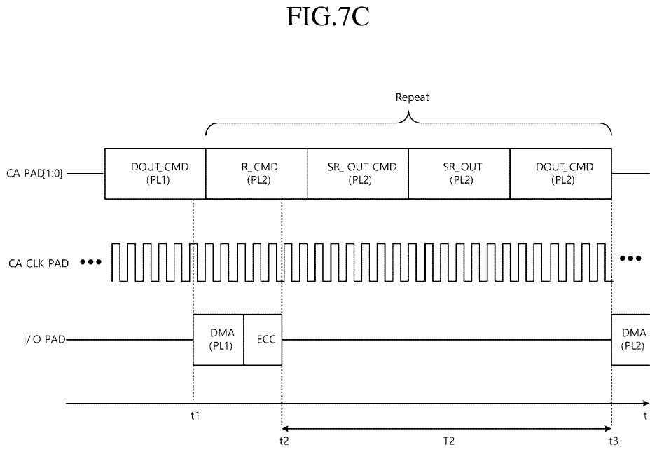

FIGS. 6A to 7C are diagrams illustrating a data output operation of a comparative example. Detailed descriptions of components overlapping with those described above with reference to FIG. 1 will be omitted below.

For example, FIG. 6A illustrates a comparative example in which data DATA, a command-address CA, and a status signal SR_OUT are all input and output through an input/output pad 13. FIG. 6B illustrates a data output sequence of the comparative example of FIG. 6A. FIG. 7A illustrates a comparative example in which data DATA is input and output through an input/output pad 13, and a command-address and a status signal SR_OUT are input and output through a command-address pad 14. FIG. 7B illustrates a data output sequence in units other than units of small pages of the comparative example of FIG. 7A. FIG. 7C illustrates a small page-based data output sequence of the comparative example of FIG. 7A.

Referring to FIG. 6A, a nonvolatile memory device 10A may include a memory cell array 11, a peripheral circuit 12, and an input/output pad 13.

The nonvolatile memory device 10A may input and output a command-address CA, data DATA, and a status signal SR_OUT through the input/output pad 13. For example, the nonvolatile memory device 200A may input and output the status signal SR_OUT and all command-address (CA) signals using the input/output pad 13 that is also used to input and output data DATA.

Accordingly, the nonvolatile memory device 10A is unable to transmit the status signal SR_OUT and the data DATA during the time for processing the command-address (CA) signal, so that it may be difficult to achieve a high level of input/output efficiency. A detailed description will be provided below with reference to FIG. 6B.

### FIG. 6B

FIG. 6B illustrates a data input/output sequence of the nonvolatile memory device 10A according to the comparative example of FIG. 6A. The data input/output sequence of the nonvolatile memory device 10A will be described with reference to a plane PL1, as an example.

At time t1, the nonvolatile memory device 10A may receive a read command R_CMD and an address ADDR through the input/output pad (I/O PAD) 13.

At time t2, the nonvolatile memory device 10A may receive a status signal output command SR_OUT CMD requesting an output of a status signal SR_OUT for checking an operation status of the plane PL1, through the input/output pad (I/O PAD) 13.

At time t3, the nonvolatile memory device 10A may output a status signal SR_OUT corresponding to the operation status of the plane PL1 in response to the received status signal output command SR_OUT CMD through the input/output pad (I/O PAD) 13.

At time t4, the nonvolatile memory device 10A may first receive an output command DOUT_CMD through the input/output pad (I/O PAD) 13.

At time t5, the nonvolatile memory device 10A may output at least a portion of the data DATA stored in the plane PL1 through the input/output pad (I/O PAD) 13.

At time t6, the nonvolatile memory device 10A may perform an error correction code (ECC) operation to correct an error of the output data DATA. The above-described processes may be repeated for all of the plurality of planes PL1 to PLN.

As a result, the nonvolatile memory device 10A inputs and outputs all of the command-address (CA) signal, the data DATA, and the status signal SR_OUT through the input/output pad (I/O PAD) 13, and thus is unable to perform parallel processing of the command-address (CA) signal, the data DATA, and the status signal SR_OUT. Therefore, it may be difficult to have a high level of input/output efficiency.

Unlike the comparative example of FIG. 6A, the nonvolatile memory device 200 according to embodiments may include an input/output pad 230, a command-address pad 240, and a status output pad 250, and thus may perform parallel processing of the command-address (CA) signal, the data DATA, and the status signal SR_OUT. Therefore, the data input/output efficiency of the storage system 1000 may be improved.

Referring to FIG. 7A, a nonvolatile memory device 10B may include a memory cell array 11, a peripheral circuit 12, an input/output pad 13, and a command-address pad 14.

The nonvolatile memory device 10B may input and output data DATA through the input/output pad 13. The nonvolatile memory device 10B may receive a command-address (CA) signal or output a status signal SR_OUT through the command-address pad 14.

Accordingly, the nonvolatile memory device 10B may include an additional command-address pad 14 that is separate from the input/output pad 13, so that the data DATA may be transmitted while transmitting or processing the command-address (CA) signal.

### FIG. 7B

FIG. 7B illustrates a data input/output sequence of the nonvolatile memory device 10B according to the comparative example of FIG. 7A. The data input/output sequence of the nonvolatile memory device 10B will be described with reference to a plane PL1 and a plane PL2 as examples.

A size of output data DATA in the comparative example of FIG. 7B may be 4 KB. However, this is only an example, and the size of the output data DATA put in the comparative example of FIG. 7B may be greater or smaller than 4 KB.

At time t1, the nonvolatile memory device 10B may output at least a portion of the data DATA stored in the plane PL1 through the input/output pad (I/O PAD) 13 in response to an output command DOUT_CMD received through the command-address pad (CA PAD) 14.

Also, at time t1, the nonvolatile memory device 10A may receive a read command R_CMD and an address ADDR through the command-address pad (CA PAD) 14.

At time t2, the nonvolatile memory device 10B may receive a command SR_OUT CMD and an address ADDR through the command-address pad (CA PAD) 14. The nonvolatile memory device 10B may be outputting at least a portion of the data DATA stored in the plane PL1 through the input/output pad (I/O PAD) 13.

At time t3, the nonvolatile memory device 10B may output a status signal SR_OUT corresponding to the operation status of the plane PL2 in response to the received status signal output command SR_OUT CMD through the command-address pad (CA PAD) 14. The nonvolatile memory device 10B may be outputting at least a portion of the data DATA stored in the plane PL1 through the input/output pad (I/O PAD) 13.

At time t4, the nonvolatile memory device 10B may complete an ECC operation for correcting an error of the output data DATA of the plane PL1.

At time t5, the nonvolatile memory device 10B may terminate the output of the status signal SR_OUT and receive an output command DOUT_CMD from the memory controller 100 through the command-address pad (CA PAD) 14.

At time t6, the nonvolatile memory device 10B may output at least a portion of the data DATA stored in the plane PL2 in response to the output command DOUT_CMD received at time t5.

As a result, the nonvolatile memory device 10B may include an additional command-address pad (CA PAD) 14 that is separate from the input/output pad (I/O PAD) 13, and thus may perform parallel processing of a command-address CA for the plane PL2 during the time for outputting the data DATA stored in the plane PL1.

The latency of the comparative example of FIG. 6B may be a time interval T1 from time t4 to time t6.

### FIG. 7C

FIG. 7C illustrates a small page-based data input/output sequence of the nonvolatile memory device 10B according to the comparative example of FIG. 7A. The small page-based data input/output sequence of the nonvolatile memory device 10B will be described with reference to a plane PL1 and a plane PL2, as example. Components overlapping with those described above with reference to FIG. 7B will be omitted to avoid redundancy.

A size of the data DATA output in the comparative example of FIG. 7C may be 512B. However, this is only an example, and the size of the data DATA output in the comparative example of FIG. 7C may be greater or smaller than 512B.

At time t1, the nonvolatile memory device 10B may output at least a portion of the data DATA stored in the plane PL1 through the input/output pad (I/O PAD) 13 in response to a received output command DOUT_CMD through the command-address pad (CA PAD) 14.

At time t2, the nonvolatile memory device 10B may have already completed the output and the ECC operation of the data DATA stored in the plane PL1. The nonvolatile memory device 10B may still be processing a read command R_CMD for the plane PL2 received through the command-address pad (CA PAD) 14. This may be because the size of the data DATA output in the comparative example of FIG. 7C is smaller than that of the comparative example of FIG. 7B.

At time t3, the nonvolatile memory device 10B may output at least a portion of the data DATA stored in the plane PL2 in response to the received output command DOUT_CMD while completing the output of the status signal SR_OUT.

The nonvolatile memory device 10B may have a latency of time T2 between time t2 and time t3. In FIG. 7C, the latency of the time T2 may be longer than the latency time T1 of the comparative example of FIG. 7B. This may be because the size of the data DATA output in the comparative example of FIG. 7C is smaller than that of the comparative example of FIG. 7B.

As a result, in a small page-based data input/output sequence in which the size of the output data DATA is small, the data input/output efficiency may be degraded due to an increase in latency as the time for outputting the data DATA of each plane is reduced.

Unlike the comparative example of FIG. 7A, the nonvolatile memory device 200 according to embodiments may include a separate status output pad 250, and thus may perform parallel processing of the command-address CA and the status signal SR_OUT.

Accordingly, in the storage system 1000, the status signal SR_OUT may have already been output before the input of the output command DOUT_CMD, so that the latency may be reduced by the time required for the status signal (SR_OUT) output request operation and the status signal (SR_OUT) output operation.

### FIGS. 8A-8C

FIGS. 8A-8C are diagrams illustrating a data input/output sequence of the storage system 1000 according to embodiments of FIG. 1.

A size of the data DATA output by the storage system 1000 described in FIGS. 8A to 8C may be 512B. However, this is only an example, and the size of the data DATA output by the storage system 1000 may be greater or smaller than 512B.

In embodiments of FIG. 8A, at time t1, the nonvolatile memory device 200 may receive a first command CMD_1 and an address ADDR through the command-address pad (CA PAD[1:0]) 240 based on a command-address clock CA_CLK from the memory controller 100. The first command CMD_1 may be a command requesting to sequentially output the status signal SR_OUT of each of the plurality of memory chips Chip_1 to Chip_M starting from the first memory chip Chip_1.

For example, the memory controller 100 of the storage system 1000 does not need to individually transmit a plurality of commands requesting to output the status signal SR_OUT of each of the plurality of memory chips Chip_1 to Chip_M.

Instead, the nonvolatile memory device 200 autonomously and sequentially outputs the status signal SR_OUT of each of the plurality of memory chips Chip_1 to Chip_M through the status output pad (SR OUT PAD) 250 in response to the first command CMD_1, so that the data input/output efficiency of the storage system 1000 may be improved.

At time t2, the nonvolatile memory device 200 may start to sequentially output the status signal SR_OUT of each of the plurality of memory chips Chip_1 to Chip_M starting from the first memory chip Chip_1 in response to the first command CMD_1. The status signal SR_OUT may be output based on a status output clock SR CLK.

For example, the nonvolatile memory device 200 may autonomously generate a status output clock SR CLK and output the status output clock SR CLK through a status output clock pad SR CLK PAD. The nonvolatile memory device 200 may output the status signal SR_OUT in synchronization with a rising edge or a falling edge of the status output clock SR CLK.

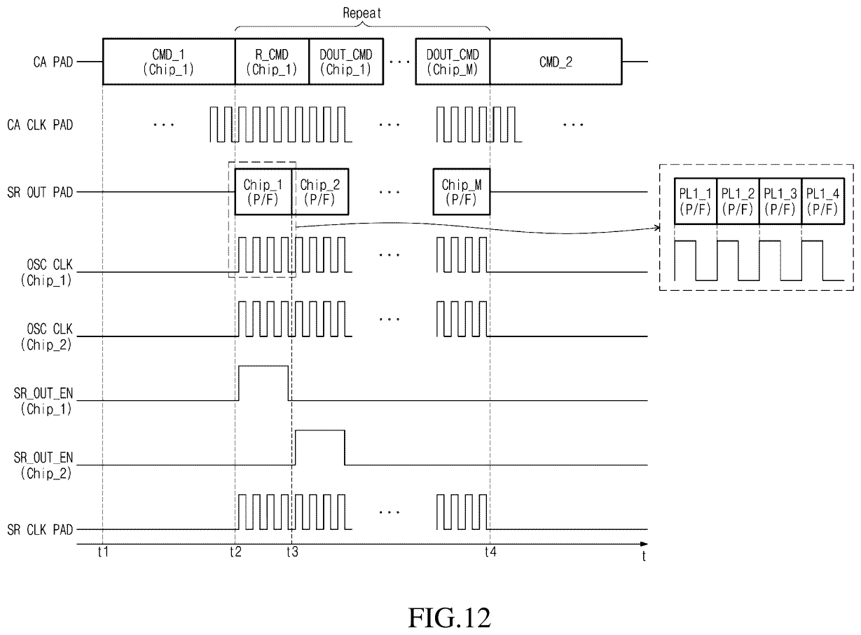

In embodiments, the nonvolatile memory device may generate the status output clock SR_CLK based on a received command-address clock CA_CLK. A detailed description will be provided later with reference to FIGS. 12-16.

Also, for example, the nonvolatile memory device 200 may sequentially output the status signal SR_OUT of each of the memory chips from the first memory chip Chip_1 to an Mth memory chip Chip_M through the status output pad (SR OUT PAD) 250. Each status signal SR_OUT may be a first status signal P or a second status signal F.

Also, for example, the nonvolatile memory device 200 may sequentially output the status signal SR_OUT of each memory chip for each plane. By taking the first memory chip Chip_1 as an example, the status signal SR_OUT of each plane may be sequentially output from a first plane PL1_1 to an Nth plane PL1_N.

At a time that is substantially the same as time t2, the memory controller 100 may transmit a read command R_CMD and an address ADDR to the nonvolatile memory device 200. However, this is only an example, and the memory controller 100 may transmit a read command R_CMD and an address ADDR to the nonvolatile memory device 200 at a certain time after time t2 and before time t3.

At time t3, the nonvolatile memory device 200 may receive an output command DOUT_CMD through the command-address pad (CA PAD) 240.

At time t4, at least a portion of the data DATA stored in the first memory chip Chip_1 may be output through the input/output pad (I/O PAD) 230 in response to the output command DOUT_CMD. This is because the output of the status signal SR_OUT of the first memory chip Chip_1 has already been completed before time t4 through the status output pad (SR OUT PAD) 250.

At time t5, the output operation and the ECC operation of the data DATA stored in the first memory chip Chip_1 of the nonvolatile memory device 200 may be terminated.

At time t6, at least a portion of the data DATA stored in a second memory chip Chip_2 may be output through the input/output pad (I/O PAD) 230 in response to the output command DOUT_CMD. This is because the output of the status signal SR_OUT of the second memory chip Chip_2 has already been completed before time t6 through the status output pad (SR OUT PAD) 250.

As a result, the storage system 1000 illustrated in FIG. 1 may perform data (DATA) output operations between planes with a shorter latency time, a time interval T3, compared to the latency time, a time T2, of the comparative example illustrated in FIG. 7C. Accordingly, the data input/output efficiency of the storage system 1000 shown in FIG. 1 may be improved.

At time t7, the nonvolatile memory device 200 may receive a second command CMD_2. The second command CMD_2 may be a command requesting to terminate the sequential output operation of the status signal SR_OUT of each of the plurality of memory chips Chip_1 to Chip_M.

Alternatively, after receiving an output command DOUT_CMD for the Mth memory chip Chip_M, the nonvolatile memory device 200 may receive a second command CMD_2 and an address ADDR. The second command CMD_2 may be a command requesting to terminate the sequential output operation of the status signal SR_OUT of each of the plurality of memory chips Chip_1 to Chip_M, with the Mth memory chip Chip_M being the last.

However, this is only an example. After the output of the status signal SR_OUT of the Mth memory chip Chip_M is completed, the second command CMD_2 may not be input to the nonvolatile memory device 200 and the status signal SR_OUT output operation may be repeated again starting from the first memory chip Chip_1.

The input timing of the second command CMD_2 may be selectively controlled by the memory controller 100. This may be aimed at ensuring that the first status signal P is output from all the memory chips Chip_1 to Chip_M.

As described above, in the storage system 1000, the nonvolatile memory device 200 may autonomously and sequentially output a status signal SR_OUT through the status output pad (SR OUT PAD) 250 based on the first command CMD_1 and the second command CMD_2. The nonvolatile memory device 200 may output the status signal SR_OUT based on an autonomously generated status output clock SR CLK, and the generated status output clock SR_OUT may be output through a status output clock pad SR CLK PAD.

Accordingly, parallel processing of data DATA, a status signal SR_OUT, and a command-address (CA) signal may be performed in the storage system 1000, so that the data input/output efficiency may be improved.

In addition, in the storage system 1000, the status signal SR_OUT may have already been output before the input of the output command DOUT_CMD. Therefore, compared to the comparative example of FIG. 7A, the latency of the storage system 1000 may be reduced by the time required for the status signal (SR_OUT) output request operation and the status signal (SR_OUT) output operation.

In embodiments of FIG. 8B, at time t1, the nonvolatile memory device 200 may receive a first command CMD_1 and an address ADDR through the command-Attorney address pad (CA PAD[1:0]) 240 from the memory controller 100 based on a command-address clock CA_CLK. Descriptions of components overlapping with those of embodiments of FIG. 8A will be omitted below.

At time t2, the nonvolatile memory device 200 may start to sequentially output the status signal SR_OUT of each of the plurality of memory chips Chip_1 to Chip_M starting from the first memory chip Chip_1, in response to the first command CMD_1.

In the case of FIG. 8B, unlike embodiments of FIG. 8A, the nonvolatile memory device 200 may not autonomously generate a status output clock SR_CLK. For example, the nonvolatile memory device 200 may not include a status output clock pad SR CLK PAD.

For example, the nonvolatile memory device 200 may transmit only information corresponding to the status signal SR_OUT to the memory controller 100. The memory controller 100 may receive information corresponding to the status signal SR_OUT based on a clock signal generated autonomously in the memory controller 100.

In embodiments of FIG. 8C, at time t1, the nonvolatile memory device 200 may receive a first command CMD_1 and an address ADDR through the command-address pad (CA PAD[1:0]) 240 based on the command-address clock CA_CLK from the memory controller 100. Descriptions of components overlapping with those of the embodiments of FIGS. 8A and 8B will be omitted below.

At time t2, the nonvolatile memory device 200 may start to sequentially output the status signal SR_OUT of each of the plurality of memory chips Chip_1 to Chip_M starting from the first memory chip Chip_1, in response to the first command CMD_1.

In the case of FIG. 8C, unlike the embodiments of FIGS. 8A and 8B, the nonvolatile memory device 200 may output the status signal SR_OUT based on the command-address clock CA_CLK received through the command-address pad CA PAD[1:0]. For example, the nonvolatile memory device 200 may not include a status output clock pad SR CLK PAD.

For example, the nonvolatile memory device 200 may output the status signal SR_OUT of each of the planes PL1_1 to PL1_4 in synchronization with a rising edge of the command-address clock CA_CLK.

However, the embodiments of FIGS. 8A to 8C are only examples of the storage system 1000 of FIG. 1, and the embodiments of the storage system 1000 are not limited thereto.

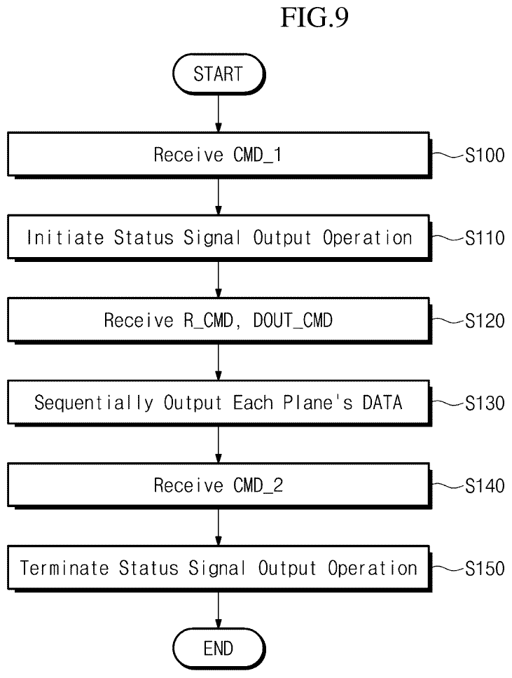

### FIG. 9

FIG. 9 is a flowchart illustrating an operation of the nonvolatile memory device 200 according to embodiments.

Referring to FIG. 9, in operation S100, the nonvolatile memory device 200 may receive a first command CMD_1 from the memory controller 100. The nonvolatile memory device 200 may receive an address ADDR of a memory chip to start a status signal (SR_OUT) output operation along with the first command CMD_1.

In operation S110, the nonvolatile memory device 200 may start the status signal (SR_OUT) output operation for each of the plurality of memory chips Chip_1 to Chip_M in response to the first command CMD_1. For example, in operation S100, the nonvolatile memory device 200 may sequentially output the status signal SR_OUT of each memory chip starting from the memory chip corresponding to the address ADDR received along with the first command CMD_1.

In operation S120, the nonvolatile memory device 200 may receive a read command R_CMD and an output command DOUT_CMD from the memory controller 100. The nonvolatile memory device 200 may receive the address ADDR of each memory chip together.

In operation S130, the nonvolatile memory device 200 may output at least a portion of the data DATA of each of the plurality of memory chips in response to the read command R_CMD and the output command DOUT_CMD.

In operation S140, the nonvolatile memory device 200 may receive a second command CMD_2 from the memory controller 100.

In operation S150, the nonvolatile memory device 200 may terminate the status signal (SR_OUT) output operation of each of the plurality of memory chips Chip_1 to Chip_N in response to the second command CMD_2.

As described above, the storage system 1000 according to embodiments may separately and sequentially output a status signal SR_OUT of each of the plurality of planes PL1_1 to PL1_N through the status output pad 250 based on the first command CMD_1 and the second command CMD_2.

Accordingly, the time required for a request and an actual output of the status signal SR_OUT may be reduced from the time until data DATA is actually output in response to the read command R_CMD and the output command DOUT_CMD by the nonvolatile memory device 200. As a result, the nonvolatile memory device 200 may have improved data input/output efficiency.

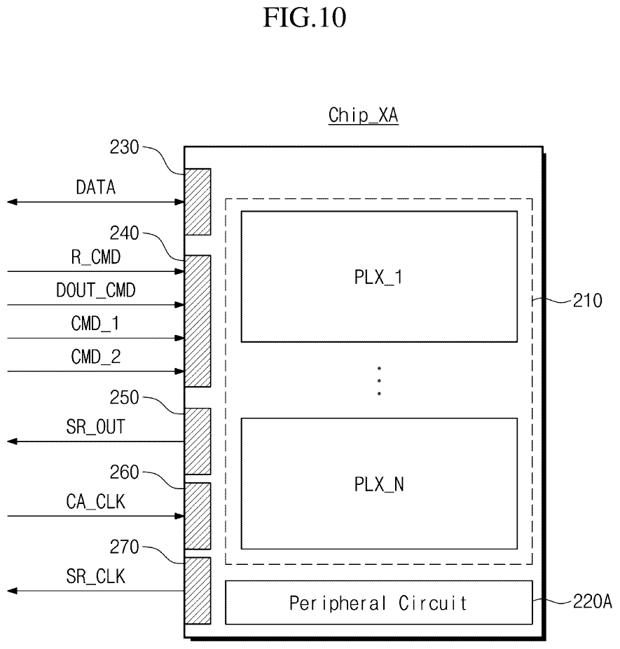

### FIG. 10

FIG. 10 is a diagram illustrating a nonvolatile memory device 200A according to embodiments.

Referring to FIG. 10, the nonvolatile memory device 200A will be described by way of example of an arbitrary memory chip Chip_XA, among a plurality of memory chips Chip_1 to Chip_M included in the nonvolatile memory device 200A. Detailed descriptions of components overlapping with those described above with reference to FIG. 1 will be omitted below.

The nonvolatile memory device 200A may include a memory cell array 210, a peripheral circuit 220A, an input/output pad 230, a command-address pad 240, a status output pad 250, a command-address clock pad 260, and a status output clock pad 270.

The command-address clock pad 260 may receive a command-address clock CA_CLK from the memory controller 100. The command-address clock CA_CLK may be a clock signal used to synchronize command-address (CA) transmission and reception operations between the memory controller 100 and the nonvolatile memory device 200A.

For example, the nonvolatile memory device 200A may receive a command-address (CA) signal at a rising edge of the command-address clock CA_CLK. Alternatively, the nonvolatile memory device 200A may receive the command-address (CA) signal at a falling edge of the command-address clock CA_CLK.

The status output clock pad 270 may output a status output clock SR_CLK to the memory controller 100. The status output clock SR_CLK may be a clock signal used to r synchronize status signal (SR_OUT) transmission and reception operations between the memory controller 100 and the nonvolatile memory device 200A.

For example, the nonvolatile memory device 200A may output the status signal SR_OUT at a rising edge of the status output clock SR_CLK. Alternatively, the nonvolatile memory device 200A may output the status signal SR_OUT at a falling edge of the status output clock SR_CLK.

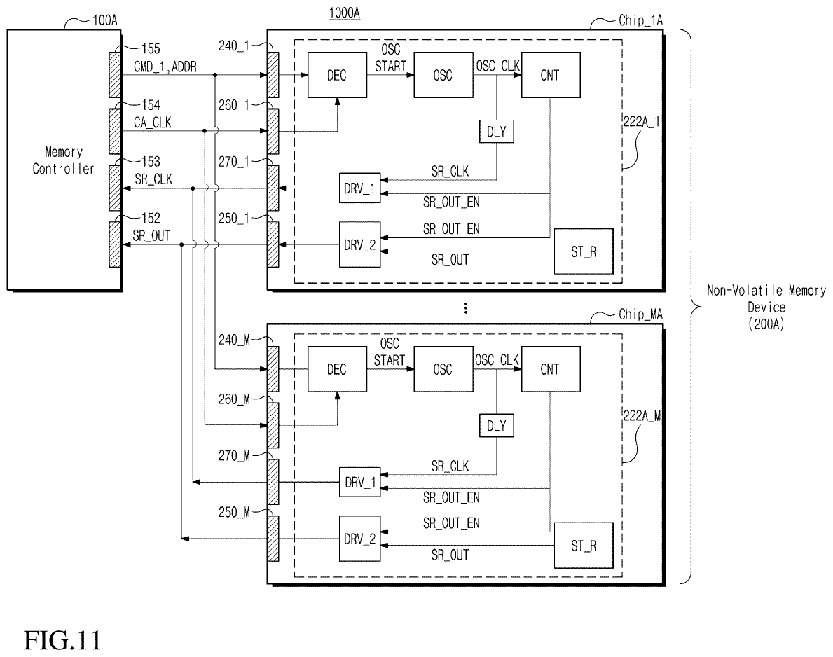

### FIG. 11

FIG. 11 is a diagram illustrating a storage system 1000A according to embodiments of FIG. 10. For clarity, an example is provided in which the nonvolatile memory device 200A includes M memory chips and each of the M memory chips includes four planes.

Referring to FIG. 11, the peripheral circuit 220A of each memory chip may include a control logic circuit 222A. The control logic circuit 222A may include a command decoder DEC, an oscillator block OSC, a counter block CNT, a delay block DLY, a status check block ST_R, a first driver DRV_1, and a second driver DRV_2.

The command decoder DEC may be electrically connected to the command-address pad 240 and a command-address clock pad 228 to receive a first command CMD_1, an address ADDR, and a command-address clock CA_CLK. In this case, the address ADDR may be address information of a memory chip to start status signal SR_OUT output. For example, the address ADDR may be an address ADDR corresponding to a first memory chip Chip_1.

The first command CMD_1 and the address ADDR may be received through the command-address pad 240, and the command-address clock CA_CLK may be received through the command-address clock pad 260.

The command decoder DEC may decode the first command CMD_1 based on the command-address clock CA_CLK and output an oscillator start signal OSC START to the oscillator block OSC.

The oscillator block OSC may output an oscillator clock signal OSC CLK based on the oscillator start signal OSC START. The oscillator clock signal OSC CLK may be input to the counter block CNT and the delay block DLY.

The operations of the command decoder DEC and the oscillator block OSC may be performed in the same manner in all memory chips. That is, in response to the first command CMD_1, the oscillator clock signal OSC CLK may be output simultaneously from the oscillator blocks OSC of all memory chips.

The counter block CNT may perform a counting operation based on the oscillator clock signal OSC CLK. In embodiments, the counter block CNT may generate a status output enable signal SR_OUT_EN and provide the generated status output enable signal SR_OUT_EN to the first driver DRV_1 and the second driver DRV_2 in a specific counting period.

The counting period may be based on the number of occurrences of rising edges of the oscillator clock signal OSC CLK. For example, a time from a first rising edge occurrence time to a second rising edge occurrence time may be referred to as a first counting period, and a time from the second rising edge occurrence time to a third rising edge occurrence time may be referred to as a second counting period.

For example, in the case of the first memory chip Chip_1, the status output enable signal SR_OUT_EN may be provided to the first driver DRV_1 and the second driver DRV_2 at every rising edge of the oscillator clock signal OSC CLK from the first to a fourth counting period. The status output enable signal SR_OUT_EN for outputting the status signal SR_OUT of a first plane PL1_1 may be output in the first counting period, the status output enable signal SR_OUT_EN for outputting the status signal SR_OUT of a second plane PL1_2 may be output in the second counting period, the status output enable signal SR_OUT_EN for outputting the status signal SR_OUT of a third plane PL1_3 may be output in the third counting period, and the status output enable signal SR_OUT_EN for outputting the status signal SR_OUT of a fourth plane PL1_4 may be output in the fourth counting period.

Alternatively, for example, in the case of an Mth memory chip Chip_M, the status output enable signal SR_OUT_EN may be provided to the first driver DRV_1 and the second driver DRV_2 at every rising edge of the oscillator clock signal OSC CLK from a (4M-3)-th counting period to a 4Mth counting period. The status output enable signal SR_OUT_EN for outputting the status signal SR_OUT of a first plane PLM_1 may be output in the (4M-3)th counting period, the status output enable signal SR_OUT_EN for outputting the status signal SR_OUT of a second plane PLM_2 may be output in the (4M-2)th counting period, the status output enable signal SR_OUT_EN for outputting the status signal SR_OUT of a third plane PLM_3 may be output in the (4M-1)th counting period, and the status output enable signal SR_OUT_EN for outputting the status signal SR_OUT of a fourth plane PLM_4 may be output in the 4Mth counting period.

The delay block DLY may provide a certain delay to the oscillator clock signal OSC CLK and provide it to the first driver DRV_1. The delayed oscillator clock signal OSC CLK may correspond to the status output clock SR_CLK.

The status check block ST_R may generate a status signal SR_OUT for each plane of the memory chip and provide the generated status signal SR_OUT to the second driver DRV_2. For example, the status check block ST_R may be electrically connected to the page buffer circuit 223. It may be checked whether the data DATA of each plane has been normally latched in the sub-page buffer circuit SPBC corresponding to each plane.

The status signal SR_OUT provided by the status check block ST_R to the second driver DRV_2 may be the first status signal P or the second status signal F.

The first driver DRV_1 may receive the status output clock SR_CLK and the status output enable signal SR_OUT_EN. The first driver DRV_1 may provide the status output clock SR_CLK to the status output clock pad 270 based on the status output enable signal SR_OUT_EN.

The status output clock SR_CLK may be output through the status output clock pad 270 and transmitted to the memory controller 100A.

For example, the first driver DRV_1 may provide the status output clock SR_CLK to the status output clock pad 270 when a voltage level of the status output enable signal SR_OUT_EN is high.

The second driver DRV_2 may receive the status signal SR_OUT and the status output enable signal SR_OUT_EN. The second driver DRV_2 may provide the status signal SR_OUT to the status output pad 250 based on the status output enable signal SR_OUT_EN.

The status signal SR_OUT may be output through the status output pad 250 and transmitted to the memory controller 100A.

For example, the second driver DRV_2 may provide the status signal SR_OUT to the status output pad 250 when the voltage level of the status output enable signal SR_OUT_EN is high.

However, this is only an example, and the operation and configuration of the control logic circuit 222A are not limited thereto.

As described above, the nonvolatile memory device 200A may receive the first command CMD_1, the address ADDR, and the command-address clock CA_CLK, and may output the status output clock SR_CLK through the status output clock pad 270. Also, the nonvolatile memory device 200A may receive the first command CMD_1, the address ADDR, and the command-address clock CA_CLK, and may output the status signal SR_OUT through the status output pad 250.

The memory controller 100A may receive the status output clock SR_CLK through a status input clock pad 153 and the status signal SR_OUT through the status input pad 152. The status signal SR_OUT may be synchronized with the status output clock SR_CLK and input to the memory controller 100A.

### FIG. 12

FIG. 12 is a diagram illustrating a data input/output sequence of the storage system 1000A according to the embodiments of FIGS. 10 and 11. Descriptions of components overlapping with those described above with reference to FIG. 11 will be omitted.

Referring to FIG. 12, at time t1, the nonvolatile memory device 200A may receive a first command CMD_1 and an address ADDR from the memory controller 100A based on a command-address clock CA CLK received from a command-address clock pad CA CLK PAD 260_1.

For example, in the case of FIG. 12, the address ADDR received by the nonvolatile memory device 200A along with the first command CMD_1 may be an address ADDR corresponding to the first memory chip Chip_1. For example, the status signal (SR_OUT) output operation may start from the first memory chip Chip_1 of the nonvolatile memory device 200A.

At time t2, the oscillator blocks OSC of all the memory chips may be activated to output an oscillator clock signal OSC CLK in response to the first command CMD_1.

At time t2, the counter block CNT of the first memory chip Chip_1 may output a status output enable signal SR_OUT_EN of the first memory chip Chip_1 based on the oscillator clock signal OSC CLK. As described above in FIG. 11, the status signal SR_OUT of each of the planes PL1_1 to PL1_4 may be output based on the status output clock SR_CLK at the rising edge of each oscillator clock signal OSC CLK in the first to fourth counting periods. The status output clock SR_CLK may be output through a status output clock pad (SR CLK PAD) 270_1.

At time t3, the counter block CNT of the second memory chip Chip_2 may output a status output enable signal SR_OUT_EN of the second memory chip Chip_2 based on the oscillator clock signal OSC CLK. As described above in FIG. 11, the status signal SR_OUT of each of the planes PL2_1 to PL2_4 may be output at the rising edge of each oscillator clock signal OSC CLK in the fifth to eighth counting periods.

At time t4, the nonvolatile memory device 200A may receive a second command CMD_2 from the memory controller 100A. Accordingly, the status signal (SR_OUT) output operation of the nonvolatile memory device 200A may be terminated. According to embodiments, the nonvolatile memory device 200A may also receive an address ADDR of the last memory chip to output a status signal SR_OUT from the memory controller 100A along with the second command CMD_2.

As described above, in the storage system 1000A, the oscillator blocks OSC of all the memory chips may be activated in response to the first command CMD_1 and the address ADDR. Then, a status output enable signal SR_OUT_EN of each memory chip may be output based on a counting period for the oscillator clock signal OSC CLK of each memory chip.

As the above operation is repeated until the second command CMD_2 is received from the memory controller 100A, the storage system 1000A may output a status signal SR_OUT through the status output pad 250. Accordingly, the data input/output efficiency of the storage system 1000A may be improved.

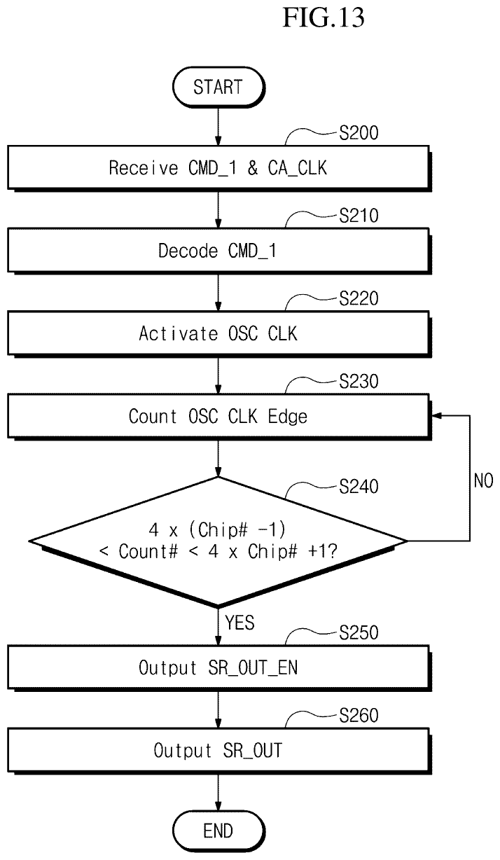

### FIG. 13

FIG. 13 is a flowchart illustrating the storage system 1000A according to the embodiments of FIGS. 10 and 11.

Referring to FIG. 13, in operation S200, the nonvolatile memory device 200A may receive a first command CMD_1 and a command-address clock CA_CLK from the memory controller 100A. The nonvolatile memory device 200A may receive the first command CMD_1 through the command-address pad 240, and may receive an address ADDR together at this point. The nonvolatile memory device 200A may receive the command-address clock CA_CLK through the command-address clock pad 260.

In operation S210, the nonvolatile memory device 200A may decode the first command CMD_1. The command decoder DEC of the control logic circuit 222A may be used.

In operation S220, the oscillator blocks OSC of all the memory chips may be activated to output an oscillator clock signal OSC CLK. in response to an oscillator start signal OSC START output by the command decoder DEC.

In operation S230, a counting operation may be performed in the counter block CNT of each memory chip. When the counting period does not satisfy operation S240, the counting operation may be repeated until operation S240 is satisfied.

In operation S250, a status output enable signal SR_OUT_EN may be output during the counting period. In operation S260, a status signal SR_OUT of the planes of each memory chip may be output in response to the status output enable signal SR_OUT_EN. For example, operations S230 to S260 may be performed at substantially the same time.

### FIG. 14

FIG. 14 is a diagram illustrating a nonvolatile memory device 200B according to embodiments.

Referring to FIG. 14, the nonvolatile memory device 200B will be described with reference to a single memory chip Chip_XB as an example, among a plurality of memory chips Chip_1A to Chip_MA included in the nonvolatile memory device 200B. Detailed descriptions of components overlapping with those described above with reference to FIG. 1 will be omitted below.

The nonvolatile memory device 200B may include a memory cell array 210, a peripheral circuit 220B, an input/output pad 230, a command-address pad 240, a status output pad 250, a command-address clock pad 260, a status output clock pad 270, a status flag input pad 280, and a status flag output pad 290.

The status flag input pad 280 may receive a status flag signal SR_FLG from a status flag output pad 290 of a memory chip Chip_(X−1)B. The status flag output pad 290 may output the status flag signal SR_FLG to a memory chip Chip_(X+1)B.

The status flag signal SR_FLG, received from other memory chips, may indicate that it is the turn of the memory chip receiving the status flag signal SR_FLG to output the status signal SR_OUT.

As a result, the nonvolatile memory device 200B may sequentially input and output the status flag signal SR_FLG, among the memory chips, to sequentially output a status signal SR_OUT for each memory chip.

As described above, the storage system 1000 according to embodiments may separately and sequentially output a status signal SR_OUT of each of the plurality of planes PL1_1 to PL1_N through the status output pad 250 based on the first command CMD_1 and the second command CMD_2.

Accordingly, the time required for a request and an actual output of the status signal SR_OUT may be reduced from the time until data DATA is actually output in response to the read command R_CMD and the output command DOUT_CMD by the nonvolatile memory device 200. As a result, the nonvolatile memory device 200 may have improved data input/output efficiency.

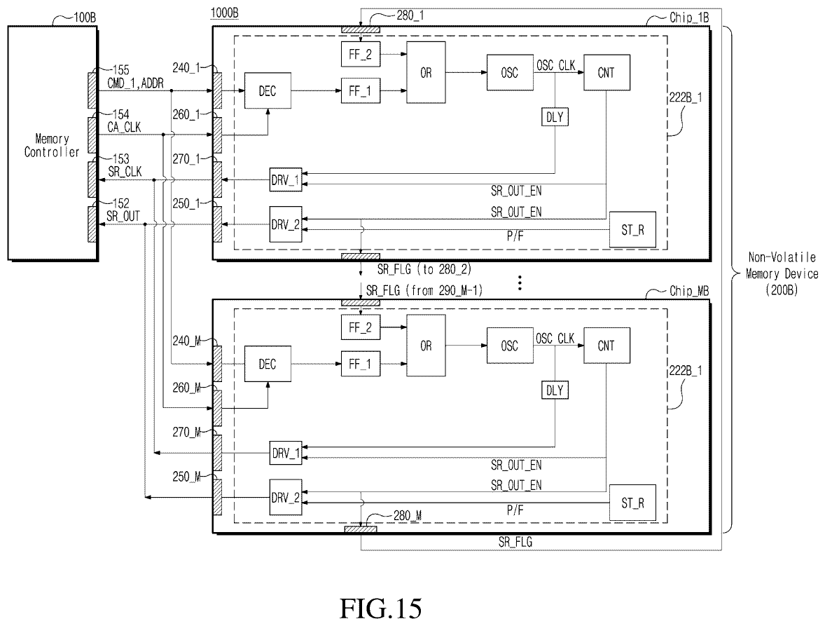

### FIG. 15

FIG. 15 is a diagram illustrating a storage system 1000B according to embodiments of FIG. 14. For clarity, an example is provided in which the nonvolatile memory device 200B includes M memory chips and each of the M memory chips included four planes.

Referring to FIG. 15, the peripheral circuit 220B of each memory chip may include a control logic circuit 222B, and the control logic circuit 222B may include a command decoder DEC, a first flip-flop FF_1, a second flip-flop FF_2, an OR gate OR, an oscillator block OSC, a counter block CNT, a delay block DLY, a status check block ST_R, a first driver DRV_1, and a second driver DRV_2.

The command decoder DEC may be electrically connected to the command-address pad 240 and a command-address clock pad 228 to receive a first command CMD_1, an address ADDR, and a command-address clock CA_CLK. The address ADDR may correspond to an address ADDR of a memory chip to initiate the output of the status signal SR_OUT.

The first command CMD_1 and the address ADDR may be received through the command-address pad 240, and the command-address clock CA_CLK may be received through the command-address clock pad 260.

The command decoder DEC may decode the first command CMD_1 and the address ADDR based on the command-address clock CA_CLK and output an oscillator start signal OSC START to the first flip-flop FF_1.

The output operation of the oscillator start signal OSC START may be performed only in the memory chip corresponding to the address ADDR received by the command decoder DEC. For example, when the command decoder DEC receives an address ADDR corresponding to the first memory chip Chip_1, the output operation of the oscillator start signal OSC START may be performed only in the first memory chip Chip_1.

Hereinafter, the address ADDR received by the command decoder DEC will be described with reference to an address ADDR corresponding to the first memory chip Chip_1, as an example.

The first flip-flop FF_1 may temporarily store the received oscillator start signal OSC START. The second flip-flop FF_2 may receive a status flag signal SR_FLG through the status flag input pad 280 and temporarily store the status flag signal SR_FLG.

An OR gate OR may receive the oscillator start signal OSC START from the first flip-flop FF_1 or the status flag signal SR_FLG from the second flip-flop FF_2. The OR gate OR may activate the oscillator block OSC when receiving the oscillator start signal OSC START or the status flag signal SR_FLG.

For example, the OR gate OR of the first memory chip Chip_1 may activate the oscillator block OSC when receiving the oscillator start signal OSC START from the first flip-flop FF_1.

Alternatively, the OR gate OR of the second memory chip Chip_2 may activate the oscillator block OSC when receiving the status flag signal SR_FLG output from a status flag output pad 290_1 of the first memory chip Chip_1 from the second flip-flop FF_2.

In embodiments, when the status signal SR_OUT output operation of all the memory chips is repeated, the OR gate OR of the first memory chip Chip_1 may receive the status flag signal SR_FLG, output from a status flag output pad 290_M of the Mth memory chip Chip_M, from the second flip-flop FF_2 and activate the oscillator block OSC.

The oscillator block OSC may output an oscillator clock signal OSC CLK based on the operation of the OR gate OR. The oscillator clock signal OSC CLK may be input to the counter block CNT and the delay block DLY.

The counter block CNT may perform a counting operation based on the oscillator clock signal OSC CLK. In one embodiment, the counter block CNT may generate a status output enable signal SR_OUT_EN and provide the generated status output enable signal SR_OUT to the first driver DRV_1 and the second driver DRV_2 for a specific number of counts.

The specific number of counts may be the number of planes included in each memory chip. For example, when each memory chip includes four planes, the counter block CNT of every memory chip may provide the status output enable signal SR_OUT_EN to the first driver DRV_1 and the second driver DRV_2 during which four counting operations are performed.

The delay block DLY may provide a certain delay to the oscillator clock signal OSC CLK and provide the delayed oscillator clock signal OSC CLK to the first driver DRV_1. The delayed oscillator clock signal OSC CLK may be the status output clock SR_CLK.

The status check block ST_R may generate a status signal SR_OUT for each plane of the memory chip and provide it to the second driver DRV_2. For example, the status check block ST_R may be electrically connected to the page buffer circuit 223. It may be checked whether the data DATA of each plane has been normally latched in the sub-page buffer circuit SPBC corresponding to each plane.

The status signal SR_OUT provided by the status check block ST_R to the second driver DRV_2 may be a first status signal P or a second status signal F.

The first driver DRV_1 may receive the status output clock SR_CLK and the status output enable signal SR_OUT_EN. The first driver DRV_1 may provide the status output clock SR_CLK to the status output clock pad 270 based on the status output enable signal SR_OUT_EN.

The status output clock SR_CLK may be output through the status output clock pad 270 and transmitted to the memory controller 100B.

For example, the first driver DRV_1 may provide the status output clock SR_CLK to the status output clock pad 270 when the voltage level of the status output enable signal SR_OUT_EN is high.

The second driver DRV_2 may receive the status signal SR_OUT and the status output enable signal SR_OUT_EN. The second driver DRV_2 may provide the status signal SR_OUT to the status output pad 250 based on the status output enable signal SR_OUT_EN.

The status signal SR_OUT may be output through the status output pad 250 and transmitted to the memory controller 100B.

For example, the second driver DRV_2 may provide the status signal SR_OUT to the status output pad 250 when the voltage level of the status output enable signal SR_OUT_EN is high.

However, this is only an example, and the operation and configuration of the control logic circuit 222B are not limited thereto.

As described above, the nonvolatile memory device 200B may receive the first command CMD_1, the address ADDR, and the command-address clock CA_CLK, and may output the status output clock SR_CLK through the status output clock pad 270. Also, the nonvolatile memory device 200A may receive the first command CMD_1, the address ADDR, and the command-address clock CA_CLK, and may output the status signal SR_OUT through the status output pad 250.

The memory controller 100B may receive the status output clock SR_CLK through a status input clock pad 153 and the status signal SR_OUT through the status input pad 152. The status signal SR_OUT may be input to the memory controller 100B in synchronization with the status output clock SR_CLK.

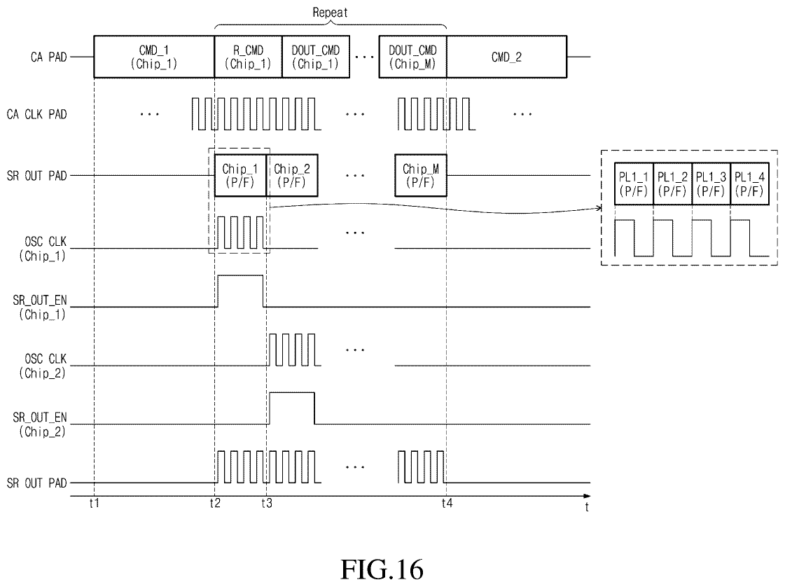

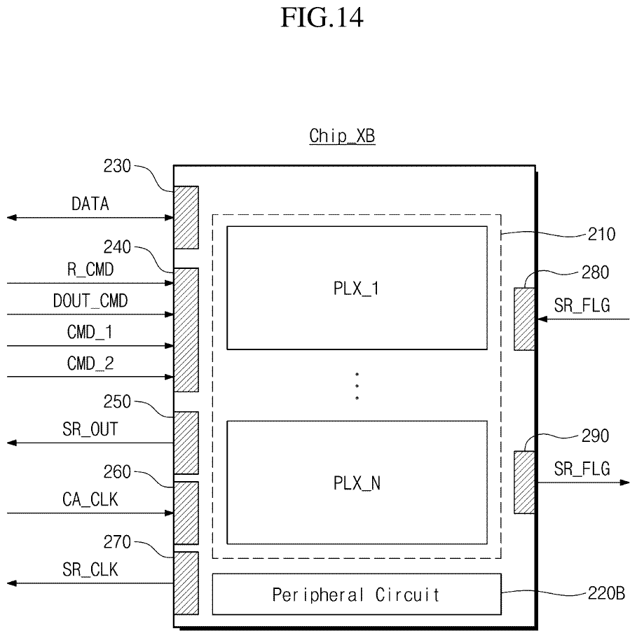

### FIG. 16

FIG. 16 is a diagram illustrating a data input/output sequence of the storage system 1000B according to the embodiments of FIGS. 14 and 15. Descriptions of components overlapping with those described above with reference to FIG. 15 will be omitted.

Referring to FIG. 16, at time t1, the nonvolatile memory device 200B may receive a first command CMD_1 and an address ADDR from the memory controller 100B based on a command-address clock CA CLK received from a command-address clock pad CA CLK PAD 260_1. For example, the address ADDR received by the nonvolatile memory device 200B along with the first command CMD_1 may be an address ADDR corresponding to the first memory chip Chip_1. The status signal (SR_OUT) output operation may be performed from the first memory chip Chip_1 of the nonvolatile memory device 200A.

At time t2, the command decoder DEC of the first memory chip Chip_1 may output an oscillator start signal OSC START in response to the first command CMD_1 and the address ADDR. The oscillator start signal OSC START may be temporarily stored in the first flip-flop FF_1 and then input to an OR gate OR. The OR gate OR may then activate the oscillator block OSC, allowing the oscillator block OSC to output an oscillator clock OSC CLK.

At time t2, the counter block CNT of the first memory chip Chip_1 may output a status output enable signal SR_OUT_EN of the first memory chip Chip_1 based on the oscillator clock signal OSC CLK. As described above in FIG. 15, the status signal SR_OUT of each of the planes PL1_1 to PL1_4 may be output based on the status output clock SR_CLK at a rising edge of each oscillator clock signal OSC CLK for every four counts. The status output clock SR_CLK may be output through a status output clock pad (SR CLK PAD) 270_1.

At time t3, the counter block CNT of the second memory chip Chip_2 may output a status output enable signal SR_OUT_EN of the second memory chip Chip_2 based on a status flag signal SR_FLG output from a status flag output pad 290_1 of the first memory chip Chip_1. As described above in FIG. 15, the status signal SR_OUT of each of the planes PL2_1 to PL2_4 may be output at the rising edge of each oscillator clock signal OSC CLK for every four counts.

At time t4, the nonvolatile memory device 200A may receive a second command CMD_2 from the memory controller 100A. Accordingly, the status signal (SR_OUT) output operation of the nonvolatile memory device 200A may be terminated. According to embodiments, the nonvolatile memory device 200A may also receive an address ADDR of the last memory chip to output a status signal SR_OUT from the memory controller 100A along with the second command CMD_2.

As described above, in the storage system 1000B, the oscillator block OSC of the memory chip corresponding to the address ADDR may be activated in response to the first command CMD_1 and the address ADDR. Then, a status output enable signal SR_OUT_EN may be output based on the number of counts for the oscillator clock signal OSC CLK of the memory chip corresponding to the address ADDR to output a status signal SR_OUT.

After the last counting operation of the memory chip corresponding to the address ADDR, a status flag signal SR_FLG may be output to a next memory chip through the status flag output pad 290 and the next memory chip may perform the status signal SR_OUT output operation in response to the status flag signal SR_FLG.

As the above operation is repeated until the second command CMD_2 is received from the memory controller 100B, the storage system 1000B may output a status signal SR_OUT through the status output pad 250. Accordingly, the data input/output efficiency of the storage system 1000B may be improved.

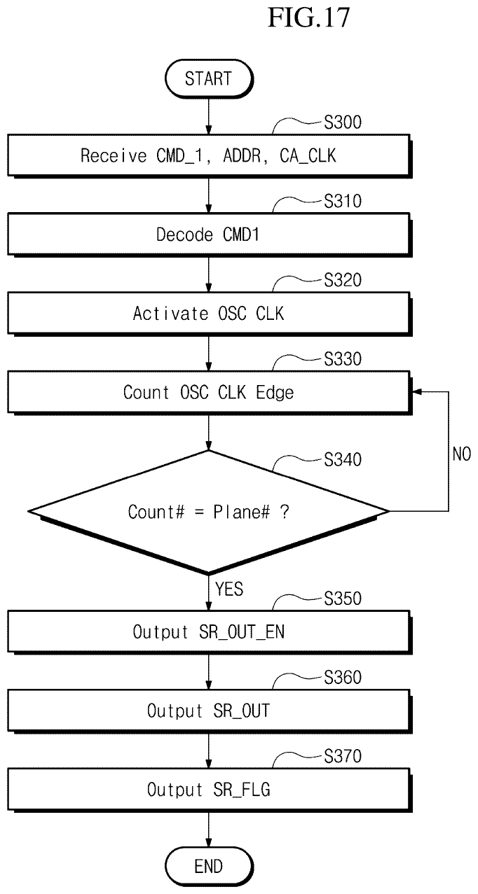

### FIG. 17

FIG. 17 is a flowchart illustrating the storage system 1000B according to the embodiments of FIGS. 14 and 15.

Referring to FIG. 17, in operation S300, the nonvolatile memory device 200B may receive a first command CMD_1, an address ADDR, and a command-address clock CA_CLK from the memory controller 100B.

The nonvolatile memory device 200B may receive the first command CMD_1 and the address ADDR through the command-address pad 240. The nonvolatile memory device 200B may receive the command-address clock CA_CLK through the command-address clock pad 260.

In operation S310, the nonvolatile memory device 200B may decode the first command CMD_1. The command decoder DEC of the control logic circuit 222A may be used.

In operation S320, the oscillator block OSC of the memory chip corresponding to the address ADDR may be activated to output an oscillator clock signal OSC CLK in response to an oscillator start signal OSC START output by the command decoder DEC.

In operation S330, a counting operation may be performed in the counter block CNT of the memory chip corresponding to the address ADDR. When the number of counts does not satisfy operation S340, the counting operation may be repeated operation S340 is satisfied.

In operation S350, a status output enable signal SR_OUT_EN may be output during the counting operation. In operation S360, a status signal SR_OUT of the planes of each memory chip may be output in response to the status output enable signal SR_OUT_EN. For example, operations S330 to S360 may be performed at substantially the same time.

In operation S370, the status signal SR_OUT output operation of the memory chip corresponding to the address ADDR may be terminated, and a status flag signal SR_FLG may be output to the next memory chip through the status flag output pad 290. Then, the next memory chip may perform a status signal (SR_OUT) output operation in response to the status flag signal SR_FLG.

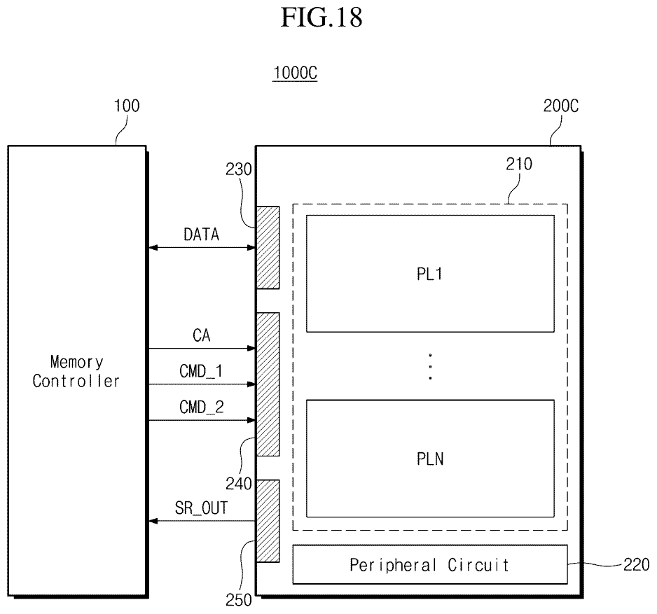

### FIGS. 18, 19, and 20

FIGS. 18-20 are diagrams illustrating storage systems according embodiments, respectively. Descriptions of components overlapping with those described above with reference to FIG. 1 will be omitted below.

Referring to FIG. 18, unlike FIG. 1, a nonvolatile memory device 200C of a storage system 1000C according to embodiments may be disposed on a single chip. A memory cell array 210 may include a plurality of planes PL1 to PLN.

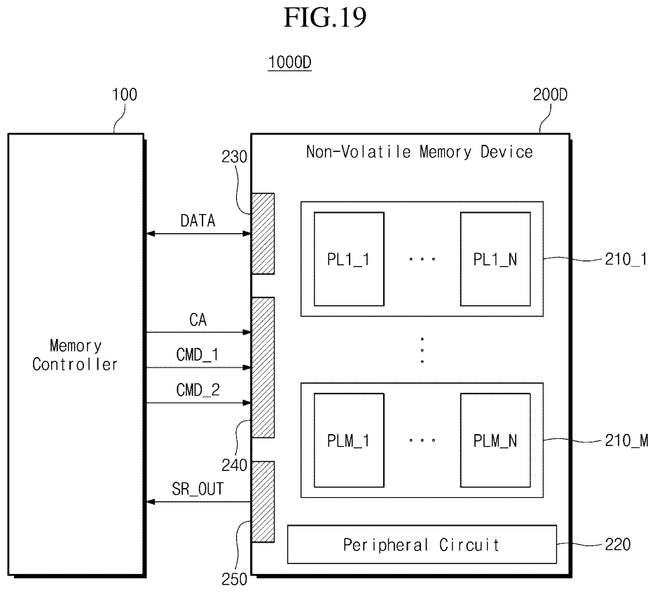

Referring to FIG. 19, unlike in FIG. 1, a nonvolatile memory device 200D of a storage system 1000D according to embodiments may be disposed on a single chip. The nonvolatile memory device 200D may include a plurality of memory cell arrays 210_1 to 210_M.

Each of the plurality of memory cell arrays 210_1 to 210_M may include a plurality of planes. For example, a first memory cell array 210_1 may include a plurality of planes PL1_1 to PL1_N. The nonvolatile memory device 200D may include a single peripheral circuit 220 to control the operation of all of the plurality of memory cell arrays 210_1 to 210_M.

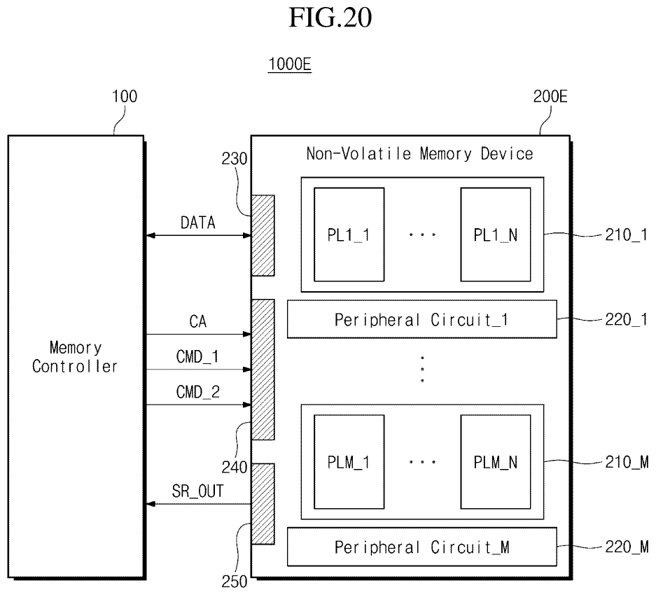

Referring to FIG. 20, unlike in FIG. 1, a nonvolatile memory device 200E of a storage system 1000E according to embodiments may be disposed on a single chip. Unlike in FIG. 19, the storage system 1000E may include a plurality of peripheral circuits 220_1 to 220_M.

Each of the plurality of peripheral circuits 220_1 to 220_M may control the operation of a one of the corresponding plurality of memory cell arrays 210_1 to 210_M. For example, a peripheral circuit 220_1 may control the operation of a memory cell array 210_1.

As set forth above, a storage system according to embodiments may improve data input/output efficiency.

While various embodiments have been shown and described above, it will be apparent to those skilled in the art that modifications and variations could be made without departing from the scope of the present disclosed concepts as defined by the appended claims.

What is claimed is:

1. A nonvolatile memory device comprising:
a plurality of memory chips,
wherein:
each of the plurality of memory chips comprises:
a memory cell array comprising a plurality of planes and configured to store data;
a command-address pad configured to receive a status output start command and an output command;
at least one status output pad configured to sequentially output status signals, respectively corresponding to operating statuses of the plurality of planes, based on the status output start command; and
an input/output pad configured to sequentially output at least a portion of data stored in the plurality of planes based on the status signal and the output command.

2. The nonvolatile memory device of claim 1, wherein:
the command-address pad is further configured to receive a status output termination command; and
each of the at least one status output pad is configured to terminate the operation of sequentially outputting the status signals for the plurality of planes based on the status output termination command.

3. The nonvolatile memory device of claim 1, further comprising:
a command-address clock pad configured to receive a command-address clock signal.

4. The nonvolatile memory device of claim 3, wherein:
the nonvolatile memory device is configured to output the status signal based on the command-address clock signal.

5. The nonvolatile memory device of claim 3, further comprising:
a status output clock pad configured to output a status output clock signal,
wherein:
the nonvolatile memory device is configured to generate the status output clock signal based on the command-address clock signal and to output the status signal based on the status output clock signal.

6. The nonvolatile memory device of claim 5, wherein:
the status output clock signal has the same clock period as the command-address clock signal and has a different level from a level of the command-address clock signal in at least a portion of a time interval.

7. The nonvolatile memory device of claim 1, wherein:
the command-address pad is further configured to receive a read command; and
a unit of a data output operation performed in response to the output command is smaller than a unit of a data read operation performed in response to the read command.

8. A method of operating a nonvolatile memory device, the method comprising:
receiving a status output start command;
sequentially outputting at least one status signal corresponding to an operating status of a data read operation on each of a plurality of planes based on the status output start command;
receiving an output command;
sequentially outputting at least a portion of data stored in the plurality of planes based on the output command;
receiving a status output termination command; and
terminating the output of the at least one status signal based on the status output termination command.

9. The method of claim 8, wherein:
the sequentially outputting of the at least one status signal further comprises:
receiving a command-address clock signal; and
sequentially outputting the at least one status signal based on the command-address clock signal.

10. The method of claim 8, wherein:
the sequentially outputting of the at least one status signal further comprises:
receiving a command-address clock signal;
generating a status output clock signal based on the command-address clock signal; and
sequentially outputting the at least one status signal based on the status output clock signal.

11. The method of claim 10, wherein:
the status output clock signal has a same clock period as a clock period of the command-address clock signal and has a different level from a level of the command-address clock signal in at least a portion of a time interval.

12. The method of claim 8, further comprising:
receiving a read command,
wherein:
a unit of a data output operation performed in response to the output command is smaller than a unit of a data read operation performed in response to the read command.

13. A storage system comprising:
a nonvolatile memory device configured to store data; and
a memory controller configured to receive data from the nonvolatile memory device or provide data to the nonvolatile memory device,
wherein:
the memory controller is configured to generate and output a status output start command and an output command;
the nonvolatile memory device comprises a plurality of memory chips; and
each of the plurality of memory chips comprises:
a memory cell array comprising a plurality of planes and configured to store data;
a command-address pad configured to receive the status output start command and the output command;
at least one status output pad configured to sequentially output status signals, respectively corresponding to operating statuses of the plurality of planes, based on the status output start command; and
an input/output pad configured to sequentially output at least a portion of data stored in the plurality of planes based on the status signal and the output command.

14. The storage system of claim 13, wherein:
the memory controller is configured to generate a status input clock signal and to receive the status signals sequentially output based on the status input clock signal.

15. The storage system of claim 13, wherein:
the memory controller is configured to generate and output a command-address clock signal; and
each of the plurality of memory chips further comprises a command-address clock pad configured to receive the command-address clock signal.

16. The storage system of claim 15, wherein:
each of the plurality of memory chips is configured to output the status signal based on the command-address clock signal.

17. The storage system of claim 15, wherein:
each of the plurality of memory chips further comprises a status output clock pad configured to output a status output clock signal; and
each of the plurality of memory chips is configured to generate the status output clock signal based on the command-address clock signal and to output the status signal based on the status output clock signal.

18. The storage system of claim 17, wherein:
the status output clock signal has a same clock period as a clock period of the command-address clock signal and has a different level from a level of the command-address clock signal in at least a portion of a time interval.

19. The storage system of claim 13, wherein:
the command-address pad is further configured to receive a status output termination command; and
each of the at least one status output pad is configured to terminate an operation of sequential outputting status signals for the plurality of planes based on the status output termination command.

20. The storage system of claim 13, wherein:
the memory controller is further configured to generate and output a read command;
the command-address pad is further configured to receive the read command; and
a unit of a data output operation performed in response to the output command is smaller than a unit of a data read operation performed in response to the read command.
